(19) United States
(12) Patent Application Publication
(10) Pub. No.: US 2013/0258368 A1
(43) Pub. Date: Oct. 3, 2013

(54) COLOR MEASURING DEVICE, IMAGE FORMING APPARATUS, COLORIMETRIC SYSTEM AND COLOR MEASURING METHOD

(71) Applicants: Masahiro Shigemoto, Saitama (JP); Nobuyuki Satoh, Kanagawa (JP); Kazushi Takei, Tokyo (JP); Hideaki Suzuki, Kanagawa (JP); Satoshi Iwanami, Kanagawa (JP)

(72) Inventors: Masahiro Shigemoto, Saitama (JP); Nobuyuki Satoh, Kanagawa (JP); Kazushi Takei, Tokyo (JP); Hideaki Suzuki, Kanagawa (JP); Satoshi Iwanami, Kanagawa (JP)

(21) Appl. No.: 13/851,215

(22) Filed: Mar. 27, 2013

(30) Foreign Application Priority Data
Mar. 28, 2012 (JP) 2012-075022
Feb. 21, 2013 (JP) 2013-032538

(51) Int. Cl. H04N 1/00; H04N 1/60

(52) U.S. Cl. CPC H04N 1/00082; H04N 1/60
USPC 358/1.9; 358/504

(57) ABSTRACT

A color measuring device includes a housing; a sensor unit configured to capture an image of a region, the sensor unit being held to the housing; an illumination light source configured to illuminate the region, the illumination light source being held to the housing; a detecting unit configured to detect a distance between predetermined two points from image data of the region obtained by the sensor unit; a correcting unit configured to correct the image data including a subject whose color is to be measured according to a ratio of the detected distance to a reference distance; and a calculating unit configured to calculate a colorimetric value of the subject based on the corrected image data.

### CROSS-REFERENCE TO RELATED APPLICATIONS

The present application claims priority to and incorporates by reference the entire contents of Japanese Patent Application No. 2012-075022 filed in Japan on Mar. 28, 2012 and Japanese Patent Application No. 2013-032538 filed in Japan on Feb. 21, 2013.

### BACKGROUND OF THE INVENTION

1. Field of the Invention

The present invention relates to a color measuring device, an image forming apparatus, a colorimetric system, and a color measuring method.

2. Description of the Related Art

In an image forming apparatus such as printers, processing called color management is performed in order to suppress fluctuation of an output by a characteristic specific to a device and increase reproducibility of an output to an input. For example, the color management is performed by the following technique. First of all, an image of a color chart (patch) of a reference color is actually output by an image forming apparatus, and a color measuring device measures the color of the patch. Hereinafter, the patch whose color is measured is referred to as a “colorimetric target patch”. Then, a color conversion parameter is generated based on a difference between a colorimetric value of the color-measured colorimetric target patch and a colorimetric value of a corresponding reference color in a standard color space, and the color conversion parameter is set to the image forming apparatus. Thereafter, when outputting an image corresponding to input image data, the image forming apparatus performs color conversion on the input image data based on the set color conversion parameter, and outputs an image based on the image data which has been subjected to the color conversion. Consequently, the image forming apparatus can output an image with high reproducibility in which fluctuation of an output by a characteristic specific to a device is suppressed.

In this color management, a spectrophotometer is widely being used as color measuring device that performs colorimetry on the colorimetric target patch. The spectrophotometer can obtain spectral reflectivity for each wavelength and thus perform high-accuracy colorimetry. However, since the spectrophotometer is expensive, it is desirable to perform high-accuracy colorimetry using a cheaper device.

An example of a technique of implementing colorimetry at a low is a technique of capturing an image of a colorimetric target as a subject by an image capturing device with an image sensor and converting a RGB value of the subject obtained by the image capturing into a colorimetric value in the standard color space. For example, Japanese Patent No. 3129502 discloses a technique in which a reference color chart serving as a comparative target of a subject is placed near the subject serving as a colorimetric target, the subject and the reference color chart are simultaneously captured by a color video camera, RGB data of the subject is corrected using RGB data of the reference color chart obtained by the image capturing, and then the RGB data of the subject is converted into a colorimetric value in the standard color space.

However, in the technique discussed in Japanese Patent No. 3129502, it is difficult to maintain a positional relation among the subject, a light source, and the color video camera, and an imaging condition changes each time image capturing is performed. Thus, it is likely that it is difficult to obtain stable image data from the subject of the colorimetric target.

Therefore, there is a need to provide a color measuring device, an image forming apparatus, a colorimetric system, and a color measuring method, which are capable of acquiring stable image data from a subject of a colorimetric target and thus performing high-accuracy colorimetry.

### SUMMARY OF THE INVENTION

It is an object of the present invention to at least partially solve the problems in the conventional technology.

According to an embodiment, there is provided a color measuring device includes a housing; a sensor unit configured to capture an image of a region, the sensor unit being held to the housing; an illumination light source configured to illuminate the region, the illumination light source being held to the housing; a detecting unit configured to detect a distance between predetermined two points from image data of the region obtained by the sensor unit; a correcting unit configured to correct the image data including a subject whose color is to be measured according to a ratio of the detected distance to a reference distance; and a calculating unit configured to calculate a colorimetric value of the subject based on the corrected image data.

According to another embodiment, there is provided an image forming apparatus that includes an image output unit configured to output an image to a recording medium; and the color measuring device according to the above embodiment. The color measuring device calculates a colorimetric value of the image using the image output from the image output unit as the subject.

According to still another embodiment, there is provided a colorimetric system that includes an image capturing unit configured to capture an image of a subject whose color is to be measured; and a calculating unit configured to calculate a colorimetric value of the subject. The image capturing unit includes a housing; a sensor unit configured to capture an image of a region, the sensor unit being held to the housing; an illumination light source configured to illuminate the region, the illumination light source being held to the housing; a detecting unit configured to detect a distance between predetermined two points from image data of the region obtained by the sensor unit; and a correcting unit configured to correct the image data including a subject whose color is to be measured according to a ratio of the detected distance to a reference distance. The calculating unit calculates the colorimetric value of the subject based on the image data that has been corrected by the correcting unit.

According to still another embodiment, there is provided a color measuring method executed in a color measuring device that includes a housing, a sensor unit configured to capture an image of a region, the sensor unit being held to the housing, and an illumination light source configured to illuminate the region, the illumination light source being held to the housing. The color measuring method includes detecting a distance between predetermined two points from image data of the region obtained by the sensor unit; correcting the image data including a subject whose color is to be measured according to a ratio of the detected distance to a reference distance; and calculating a colorimetric value of the subject based on the corrected image data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating the inside of an image forming apparatus;

FIG. 2 is a top view illustrating a mechanical configuration of the inside of an image forming apparatus;

FIG. 3 is a diagram for describing an example of an elevating mechanism that moves a carriage up or down;

FIG. 4 is a diagram for describing an arrangement example of a print head mounted in a carriage;

FIG. 5A is a vertical cross-sectional view of an image capturing unit (a cross-sectional view taken along line X1-X1 of FIG. 5B);

FIG. 5B is a perspective top view illustrating the inside of an image capturing unit;

FIG. 5C is a plan view illustrating a bottom portion of a housing which is viewed from X2 direction in FIG. 5A;

FIG. 6 is diagram illustrating a concrete example of a reference chart;

FIG. 7 is a block diagram illustrating of a schematic configuration of a control mechanism of an image forming apparatus;

FIG. 8 is a block diagram illustrating a configuration example of a control mechanism of a color measuring device;

FIG. 9 is a diagram for describing processing of acquiring a reference colorimetric value and a reference RGB value and processing of generating a reference value linear conversion matrix;

FIGS. 10A and 10B illustrate an example of an initial reference RGB value;

FIG. 11 is a diagram for describing an outline of a colorimetry process;

FIG. 12 is a diagram for describing processing of generating a reference inter-RGB linear conversion matrix.

FIG. 13 is a diagram illustrating a relation between an initial reference RGB value and a colorimetry reference RGB value;

FIG. 14 is a diagram for describing a basic colorimetry process;

FIG. 15 is a diagram for describing a basic colorimetry process;

FIG. 16 is a diagram modeling a change in an optical path length and a change in a position of a subject in an image with a change in a gap d;

FIG. 17 is a diagram illustrating an example of a pattern image formed on a recording medium by an image forming apparatus;

FIG. 18 is a diagram illustrating an image obtained by capturing a pattern image illustrated in FIG. 17 through an image capturing unit;

FIG. 19 is a diagram illustrating points (p1, p1′) of an upper right corner and points (p2, p2′) of a lower right corner which are extracted from an image of an outer frame illustrated in FIG. 18;

FIGS. 20A and 20B illustrate examples of a relation between a gap change amount and a sensor output;

FIG. 21 is a diagram illustrating an example of a relation among a gap change amount, a sensor output before correction, and a value after output correction;

FIGS. 22A and 22B illustrate a surface profile of a platen plate and shape distortion of an outer frame of a pattern image formed on a recording medium;

FIG. 23 is a diagram illustrating patterns of shape distortion of an outer frame;

FIG. 24 is a flowchart illustrating the flow of a series of processes of determining whether or not colorimetry of a colorimetric target patch is to be performed according to the presence or absence of shape distortion of a pattern image;

FIG. 25 is a flowchart illustrating the flow of a series of processes of determining a distortion pattern of shape distortion of a pattern image through a determining unit;

FIG. 26 is a flowchart illustrating the flow of a series of processes of adjusting a gap d using a distance between two points detected by a detecting unit;

FIG. 27 is a flowchart illustrating the flow of a series of processes of adjusting a gap d using a distance between two points detected by a detecting unit;

FIG. 28 is a vertical cross-sectional view of an image capturing unit of a first modification;

FIG. 29 is a vertical cross-sectional view of an image capturing unit of a second modification;

FIG. 30 is a vertical cross-sectional view of an image capturing unit of a third modification;

FIG. 31 is a vertical cross-sectional view of an image capturing unit of a fourth modification;

FIG. 32A is a vertical cross-sectional view of an image capturing unit of a fifth modification;

FIG. 32B is a plan view illustrating a bottom portion of a housing in an image capturing unit of the fifth modification which is viewed from X3 direction in FIG. 32A;

FIG. 33 is a vertical cross-sectional view of an image capturing unit of a sixth modification; and

FIG. 34 is a diagram illustrating a schematic configuration of a colorimetric system.

### DETAILED DESCRIPTION OF THE PREFERRED EMBODIMENTS

Hereinafter, exemplary embodiments of a color measuring device, an image forming apparatus, a colorimetric system, and a color measuring method according to the present invention will be described in detail with reference to the accompanying drawings. The following embodiments will be described in connection with an inkjet printer as an example of an image forming apparatus according to the present invention, but the present invention can be widely applied to various types of image forming apparatuses that output an image to a recording medium.

Mechanical Configuration of Image Forming Apparatus

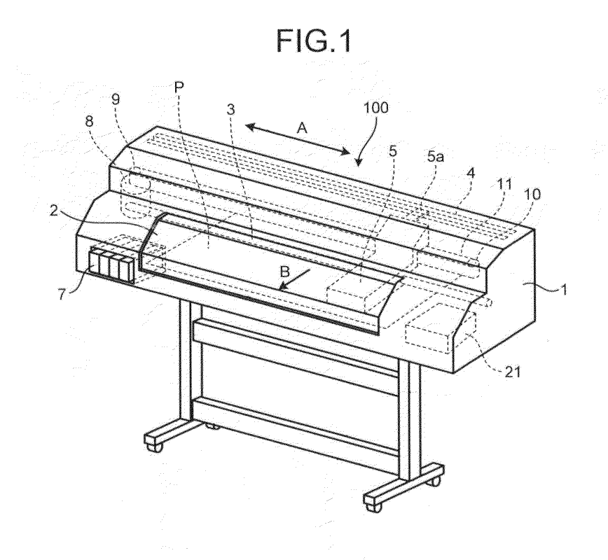

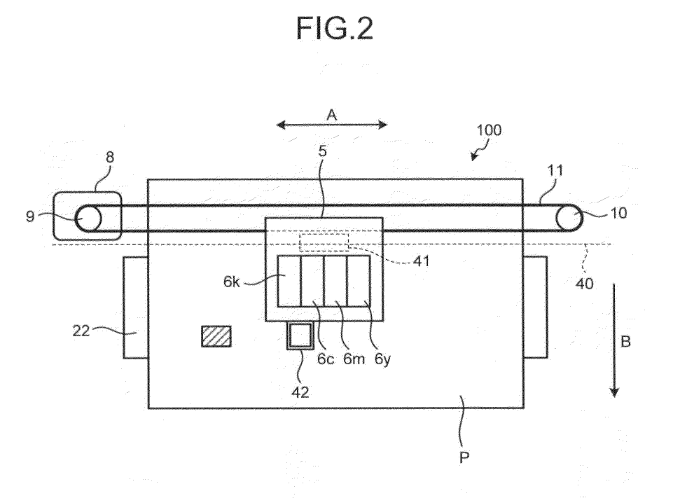

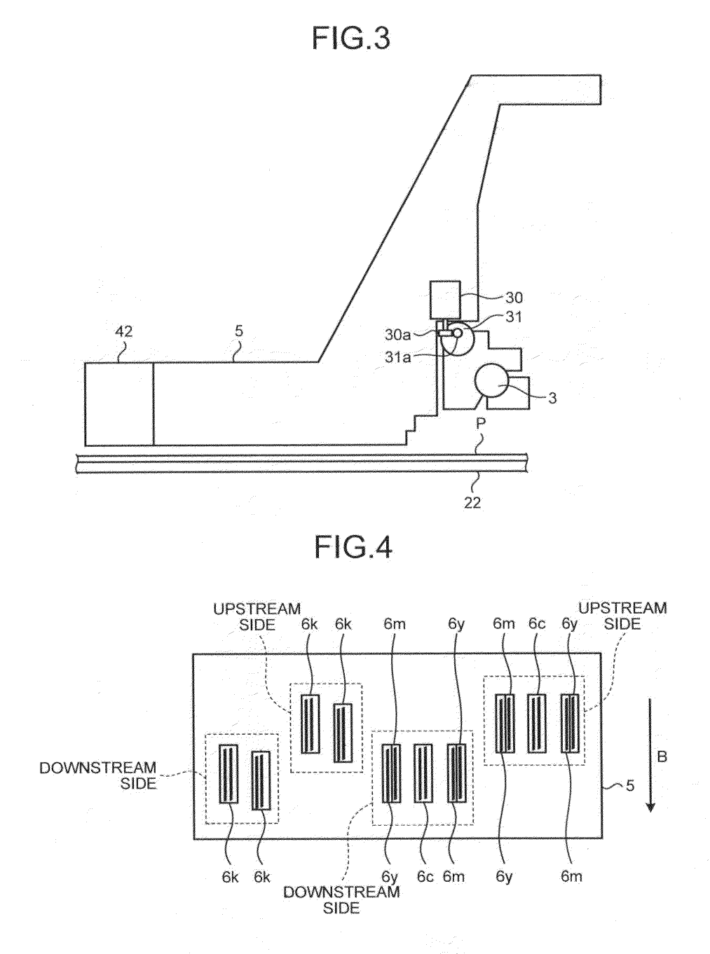

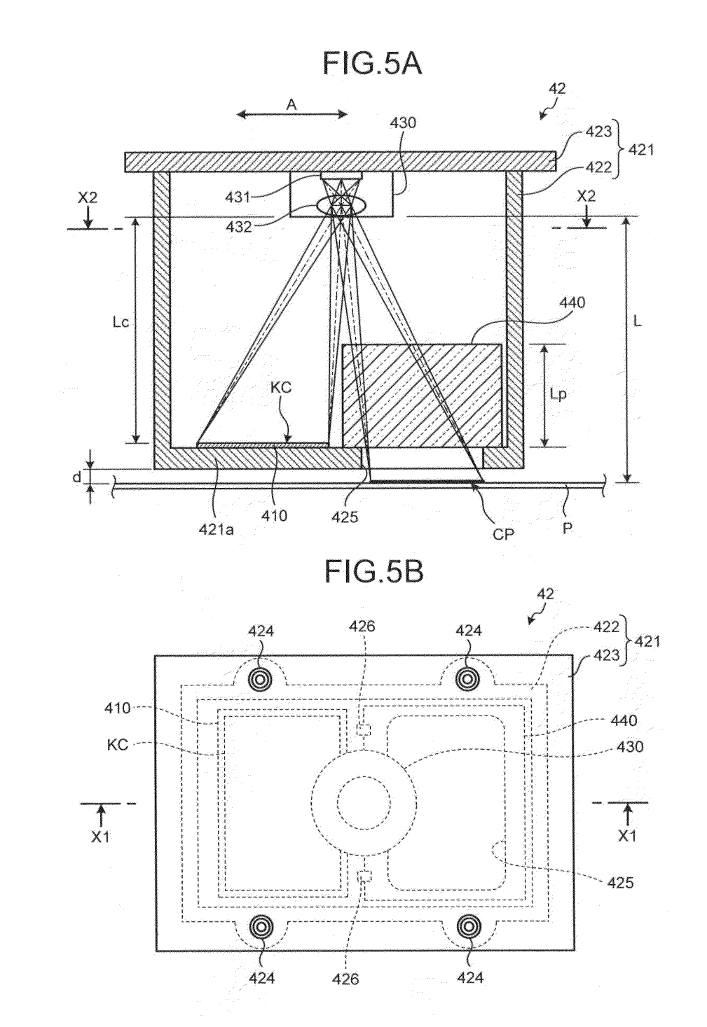

First of all, a mechanical configuration of an image forming apparatus 100 according to the present embodiment will be described with reference to FIGS. 1 to 4. FIG. 1 is a perspective view illustrating the inside of the image forming apparatus 100 according to the present embodiment, FIG. 2 is a top view illustrating a mechanical configuration of the inside of the image forming apparatus 100 according to the present embodiment, FIG. 3 is a diagram for describing an example of an elevating mechanism that moves a carriage 5 up or down, and FIG. 4 is a diagram for describing an arrangement example of a print head 6 mounted in the carriage 5.

As illustrated in FIG. 1, the image forming apparatus 100 according to the present embodiment includes the carriage 5 that reciprocates in a main-scanning direction (an arrow A direction in FIG. 1), and forms an image on a recording medium P intermittently conveyed in a sub-scanning direction (an arrow B direction in FIG. 1). The carriage 5 is supported by a main guide rod 3 installed to extend in the main-scanning direction. A connecting piece 5a is disposed in the carriage 5. The connecting piece 5a engages with a sub guide member 4 installed in parallel to the main guide rod 3, and stabilizes an attitude of the carriage 5.

The carriage 5 includes a print head 6y that ejects yellow (Y) ink, a print head 6m that ejects magenta (M) ink, a print head 6c that ejects cyan (C) ink, and a plurality of print heads 6k that eject black (Bk) ink (hereinafter, print heads 6y, 6m, 6c, and 6k are collectively referred to as a “print head 6”) as illustrated in FIG. 2. The print head 6 is mounted in the carriage 5 such that an ejecting plane (a nozzle plane) thereof is directed downward (the recording medium P side).

A cartridge 7 that is an ink supply unit supplying ink to the print head 6 is not mounted in the carriage 5 and arranged at a predetermined position in the image forming apparatus 100. The cartridge 7 is connected with the print head 6 through a pipe (not illustrated), and ink is supplied from the cartridge 7 to the print head 6 through the pipe.

The carriage 5 is coupled to a timing belt 11 stretched between a driving pulley 9 and a driven pulley 10. The driving pulley 9 rotates by driving of a main scanning motor 8. The driven pulley 10 includes a mechanism adjusting a distance from the driving pulley 9, and functions to give predetermined tension to the timing belt 11. The carriage 5 reciprocates in the main-scanning direction as the timing belt 11 is fed by driving of the main scanning motor 8. For example, movement of the carriage 5 in the main-scanning direction is controlled based on an encoder value obtained by detecting a mark of an encoder sheet 40 through an encoder sensor 41 disposed in the carriage 5 as illustrated in FIG. 2.

Further, the image forming apparatus 100 according to the present embodiment includes a maintenance mechanism 21 functioning to maintain reliability of the print head 6. The maintenance mechanism 21 performing cleaning or capping of the ejecting plane of the print head 6, discharging of unnecessary ink from the print head 6, and the like.

A platen plate 22 is disposed at the position facing the ejecting plane of the print head 6 as illustrated in FIG. 2. The platen plate 22 supports the recording medium P when ink is ejected from the print head 6 onto the recording medium P. The image forming apparatus 100 according to the present embodiment is a wide machine in which the moving distance of the carriage 5 in the main-scanning direction is long. For this reason, the platen plate 22 is configured such that a plurality of plate-like members are coupled to each other in the main-scanning direction (in the moving direction of the carriage 5). The recording medium P is sandwiched between carriage rollers driven by a sub-scanning motor (not illustrated), and intermittently conveyed on the platen plate 22 in the sub-scanning direction. Further, while conveying in the sub-scanning direction is being suspended, the recording medium P is held on the platen plate 22 by suction of a suction fan disposed on the back side (the surface opposite to the surface on which the recording medium P is placed) of the platen plate 22.

When a thick sheet such as postcards, a sheet with a strong curl such as coated sheets, or a sheet with a textured surface such as matte films is used as the recording medium P, if the distance between the recording medium P and the carriage 5 is set to the same distance as in case of using a general plain sheet, the recording medium P is likely to come in contact with the print head 6, leading to damage of the print head 6. In this regard, the image forming apparatus 100 includes an elevating mechanism that moves the carriage 5 up or down, and is configured to increase the distance between the recording medium P and the carriage 5 when the recording medium P such as a thick sheet, a coated sheet, or a matte film is used. Here, moving-up or down of the carriage 5 refers to movement of the carriage 5 in a direction in which the carriage 5 gets close to or away from the recording medium P.

For example, the elevating mechanism is configured to move the carriage 5 up or down by displacing an eccentric cam 31 by driving of a carriage elevating motor 30 as illustrated in FIG. 3. In other words, as the carriage elevating motor 30 rotates, a gear 30a mounted to a rotating shaft of the carriage elevating motor 30 rotates a shaft 31a of the eccentric cam 31. Since the shaft 31a is installed at the position displaced from the center of the eccentric cam 31, when the shaft 31a rotates, the eccentric cam 31 is displaced. The carriage 5 comes into contact with the eccentric cam 31 and thus moves up or down in a direction indicated by an arrow in FIG. 3 with the displacement of the eccentric cam 31. The elevating mechanism illustrated in FIG. 3 is merely an example, and can have any configuration as long as a function capable of moving the carriage 5 up or down is provided.

The print head 6 includes a plurality of a row of nozzles, and forms an image on the recording medium P by ejecting ink from a row of nozzles onto the recording medium P conveyed on the platen plate 22. In the present embodiment, in order to secure a large width of an image which can be formed on the recording medium P by single scanning of the carriage 5, the print head 6 are mounted at the upstream side and the downstream of the carriage 5 as illustrated in FIG. 4. Further, the print heads 6k that eject the black ink are mounted on the carriage 5 to be twice as many as the print heads 6y, 6m, and 6c that eject color ink. Further, the print heads 6y and 6m are separately arranged at the left and rights. This is to follow an overlapping order of color in a reciprocating operation of the carriage 5 so that out-bound color does not differ from in-bound color. The arrangement of the print head 6 illustrated in FIG. 4 is an example, and the present invention is not limited to the arrangement illustrated in FIG. 4.

The components configuring the image forming apparatus 100 according to the present embodiment are arranged inside a housing body 1. The cover member 2 which is openable or closable is installed on the housing body 1. At the time of the maintenance of the image forming apparatus 100 or at the time of the occurrence of a jam, the cover member 2 is opened, so that work can be carried out on the components installed inside the housing body 1.

The image forming apparatus 100 according to the present embodiment intermittently feeds the recording medium P in the sub-scanning direction, and forms an image on the recording medium P by ejecting ink from a row of nozzles of the print head 6 mounted on the carriage 5 onto the recording medium P on the platen plate 22 while moving the carriage 5 in the main-scanning direction while conveying of the recording medium P in the sub-scanning direction is being suspended.

Particularly, when color adjustment for adjusting color reproducibility of the image forming apparatus 100 is performed, ink is ejected on the recording medium P to form a colorimetric target patch CP. The colorimetric target patch CP is an image obtained by outputting a patch of a reference color through the image forming apparatus 100, and reflects output characteristics of the image forming apparatus 100. Thus, the image forming apparatus 100 can output an image with high reproducibility by generating a color conversion parameter based on a colorimetric value of the colorimetric target patch CP and outputting an image based on image data which has been subjected to color conversion using the color conversion parameter.

The image forming apparatus 100 according to the present embodiment includes a color measuring device that performs colorimetry on the colorimetric target patch CP. The color measuring device includes an image capturing unit 42 that captures an image of a subject together with a reference chart KC to be described below. The image capturing unit 42 is installed to be fixed to the carriage 5, and reciprocates in the main-scanning direction together with the carriage 5 as illustrated in FIGS. 2 and 3. Further, when the carriage 5 moves up or down by the elevating mechanism, the image capturing unit 42 moves up or down as the carriage 5 moves up or down. The reference chart KC used as a reference of a color tone in which an imaging condition under which the image capturing unit 42 performs image capturing is reflected is integrally disposed in the image capturing unit 42. Further, the image capturing unit 42 simultaneously captures the subject and the reference chart KC in a state in which the image capturing unit 42 moves to the position facing the subject with the movement of the carriage 5. Here, the simultaneous image capturing means an operation of acquiring image data of a single frame including the subject and the reference chart KC. In other words, even though data is acquired at different timings by pixels, when the image data including the subject and the reference chart KC in the single frame is acquired, it is regarded that the images of the subject and the reference chart KC are simultaneously captured.

When color adjustment of the image forming apparatus 100 is performed, the recording medium P on which the colorimetric target patch CP is formed is set on the platen plate 22. Further, with the conveying of the adjustment sheet CS and the movement of the carriage 5 by the sub-scanning motor, the image capturing unit 42 is moved to the position opposite to the colorimetric target patch CP. In this state, the image capturing unit 42 captures the colorimetric target patch CP and the reference chart KC at the same time. The color measuring device calculates a colorimetric value of the colorimetric target patch CP by a method which will be described below using image data of the colorimetric target patch CP and the reference chart KC obtained by capturing the colorimetric target patch CP as the subject through the image capturing unit 42.

Concrete Example of Image Capturing Unit

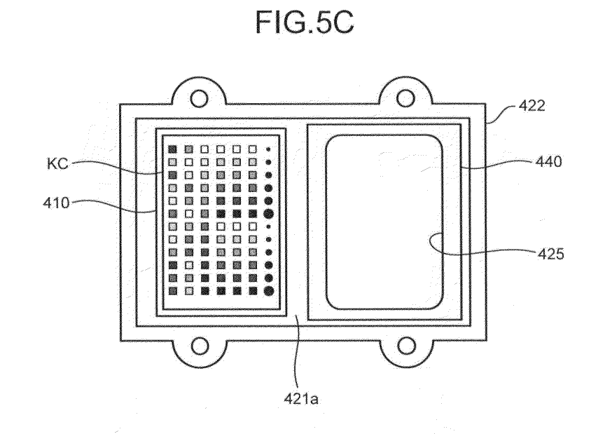

Next, a concrete example of the image capturing unit 42 will be described in detail with reference to FIGS. 5A to 5C. FIGS. 5A to 5C are diagrams illustrating a concrete example of the image capturing unit 42. FIG. 5A is a vertical cross-sectional view of the image capturing unit 42 (a cross-sectional view taken along line X1-X1 of FIG. 5B), FIG. 5B is a perspective top view illustrating the inside of the image capturing unit 42, and FIG. 5C is a plan view illustrating a bottom portion of a housing which is viewed from an X2 direction in FIG. 5A.

The image capturing unit 42 includes a housing 421 configured such that a frame 422 is combined with a substrate 423. The frame 422 is formed to have a closed-end cylindrical shape whose one end serving as the top surface of the housing 421 is opened. The substrate 423 is integrated with the frame 422 such that the substrate 423 is fastened to the frame 422 by a fastening member 424 to close an open end of the frame 422 and configure the top surface of the housing 421.

The housing 421 is fixed to the carriage 5 such that a bottom portion 421a thereof faces the recording medium P on the platen plate 22 through a predetermined gap d. An opening portion 425 through which a subject (the colorimetric target patch CP in color adjustment) formed on the recording medium P can be shot by the inside of the housing 421 is formed in the bottom portion 421a of the housing 421 facing the recording medium P.

A sensor unit 430 for capturing a predetermined region including the inside and the outside of the housing 421 is installed inside the housing 421. The sensor unit 430 includes a two-dimensional (2D) image sensor 431 such as a CCD sensor or a CMOS sensor and an imaging lens 432 that forms an optical image of the imaging area of the sensor unit 430 on a sensor plane of the 2D image sensor 431. For example, the 2D image sensor 431 is mounted on the inner surface (a part mounting surface) of the substrate 423 such that the sensor plane faces the bottom portion 421a side of the housing 421. The imaging lens 432 is fixed in a state in which the imaging lens 432 is positioned with respect to the 2D image sensor 431 to maintain a positional relation decided according to an optical characteristic thereof.

A chart board 410 on which the reference chart KC is formed is arranged on the internal side of the bottom portion 421a of the housing 421 facing the sensor unit 430 side by side with the opening portion 425 formed in the bottom portion 421a. For example, the chart board 410 adheres to the internal side of the bottom portion 421a of the housing 421 by an adhesive or the like using the surface opposite to the surface on which the reference chart KC is formed as an adhesive surface and is fixed to the housing 421 and held. The reference chart KC is captured together with the subject (the colorimetric target patch CP) by the sensor unit 430. In other words, the sensor unit 430 captures the image of the subject (the colorimetric target patch CP) outside the housing 421 through the opening portion 425 formed in the bottom portion 421a of the housing 421 while capturing the reference chart KC on the chart board 410 arranged on the internal side of the bottom portion 421a of the housing 421. The details of the reference chart KC will be described below.

Further, an optical path length changing member 440 is arranged inside the housing 421. The optical path length changing member 440 is an optical element having a refractive index n (n is an arbitrary number) at which light passes through. The optical path length changing member 440 is arranged in the middle of an optical path between the subject (the colorimetric target patch CP) outside the housing 421 and the sensor unit 430, and has a function of bringing an image formation plane of an optical image of the subject (the colorimetric target patch CP) close to an image formation plane of an optical image of the reference chart KC. In other words, in the image capturing unit 42 according to the present embodiment, as the optical path length changing member 440 is arranged in the middle of the optical path between the subject (the colorimetric target patch CP) and the sensor unit 430, both the image formation plane of the optical image of the subject (the colorimetric target patch CP) outside the housing 421 and the image formation plane of the reference chart KC inside the housing 421 are aligned with the sensor plane of the 2D image sensor 431 of the sensor unit 430. FIG. 5A illustrates the example in which the optical path length changing member 440 is placed on the bottom portion 421a of the housing 421, but the optical path length changing member 440 needs not be necessarily placed on the bottom portion 421a and needs only to be arranged in the middle of the optical path between the subject (the colorimetric target patch CP) outside the housing 421 and the sensor unit 430.

When light passes through the optical path length changing member 440, the optical path length extends according to the refractive index n of the optical path length changing member 440, and an image appears to float. The floating amount C of the image can be obtained by the following equation when the length of the optical path length changing member 440 in an optical axis direction is Lₚ:

C=Lₚ(1−1/n)

Further, when the distance between the principal point of the imaging lens 432 of the sensor unit 430 and the reference chart KC is L_{c}, the distance L between the principal point of the imaging lens 432 and the front focal plane (imaging plane) of the optical image passing through the optical path length changing member 440 can be obtained by the following equation:

L=L_{c}+Lₚ(1−1/n)

Here, when the refractive index n of the optical path length changing member 440 is 1.5, L=L_{c}+Lₚ(⅓) is established, and the optical path length of the optical image passing through the optical path length changing member 440 can be increased by about ⅓ of the length Lₚ of the optical path length changing member 440 in the optical axis direction. In this case, for example, when Lₚ is 9 [mm], L=L_{c}+3 [mm] is established. Thus, when image capturing is performed in a state in which the difference between the distance from the sensor unit 430 to the reference chart KC and the distance to the subject (the colorimetric target patch CP) is 3 mm, both the rear focal plane (the image formation plane) of the optical image of the reference chart KC and the rear focal plane (the image formation plane) of the optical image of the subject (the colorimetric target patch CP) can be aligned with the sensor plane of the 2D image sensor 431 of the sensor unit 430.

Further, an illumination light source 426 illuminates a region serving as the imaging area of the sensor unit 430, that is, a region including the subject (the colorimetric target patch CP) and the reference chart KC when the sensor unit 430 simultaneously captures the subject (the colorimetric target patch CP) and the reference chart KC is disposed inside the housing 421. For example, a light emitting diode (LED) is used as the illumination light source 426. In the present embodiment, two LEDs are used as the illumination light source 426. For example, the two LEDs used as the illumination light source 426 are mounted on the internal surface of the substrate 423 together with the 2D image sensor 431 of the sensor unit 430. Here, the illumination light source 426 is preferably arranged at the position at which the subject (the colorimetric target patch CP) and the reference chart KC can be illuminated, and needs not be necessarily mounted directly on the substrate 423.

Further, in the present embodiment, as illustrated in FIG. 5B, the two LEDs are arranged such that when the two LEDs used as the illumination light source 426 are looked down vertically from the substrate 423 toward the bottom portion 421a side of the housing 421, projection positions of the two LEDs on the bottom portion 421a are within regions between the opening portion 425 and the reference chart KC, and are symmetrical centering on the sensor unit 430. In other words, a line connecting the two LEDs used as the illumination light source 426 passes through the center of the imaging lens 432 of the sensor unit 430, and the opening portion 425 and the reference chart KC formed on the bottom portion 421a of the housing 421 are arranged at the positions which are line-symmetrical with respect to the line connecting the two LEDs. As the two LEDs used as the illumination light source 426 are arranged as described above, the subject (the colorimetric target patch CP) and the reference chart KC can be illuminated at almost the same condition.

In the present embodiment, the LED is used as the illumination light source 426, but the type of the light source is not limited to the LED. For example, an organic electroluminescence (EL) or the like may be used as the illumination light source 426. When the organic EL is used as the illumination light source 426, illumination light close to a spectral distribution of solar light is obtained, and thus the accuracy of colorimetry can be expected to be increased.

Meanwhile, in order to illuminate the subject (the colorimetric target patch CP) outside the housing 421 at the same illumination condition as the reference chart KC arranged inside the housing 421, it is necessary to illuminate the subject (the colorimetric target patch CP) by only illumination light from the illumination light source 426 in a state in which ambient light does not reach the subject (the colorimetric target patch CP) at the time of image capturing by the sensor unit 430. In order to prevent ambient light from reaching the subject (the colorimetric target patch CP), it is effective to reduce the gap d between the bottom portion 421a of the housing 421 and the recording medium P and cause ambient light directed to the subject (the colorimetric target patch CP) to be blocked by the housing 421. Here, when the gap d between the bottom portion 421a of the housing 421 and the recording medium P is too small, the recording medium P comes into contact with the bottom portion 421a of the housing 421, and thus it is difficult to appropriately perform capturing of an image. In this regard, the gap d between the bottom portion 421a of the housing 421 and the recording medium P is preferably set to a small value within a range in which the recording medium P does not come into contact with the bottom portion 421a of the housing 421 in view of flatness of the recording medium P. For example, when the gap d between the bottom portion 421a of the housing 421 and the recording medium P is set to about 1 mm to 2 mm, the recording medium P does not come into contact with the bottom portion 421a of the housing 421, and thus it is possible to effectively prevent ambient light from reaching the subject (the colorimetric target patch CP) formed on the recording medium P.

Further, in order to appropriately apply illumination light from the illumination light source 426 to the subject (the colorimetric target patch CP), it is preferable to increase the size of the opening portion 425 formed in the bottom portion 421a of the housing 421 to be larger than the subject (the colorimetric target patch CP) and to make a shadow occurring when illumination light is blocked at the end edge of the opening portion 425 not reflected on the subject (the colorimetric target patch CP).

Concrete Example of Reference Chart

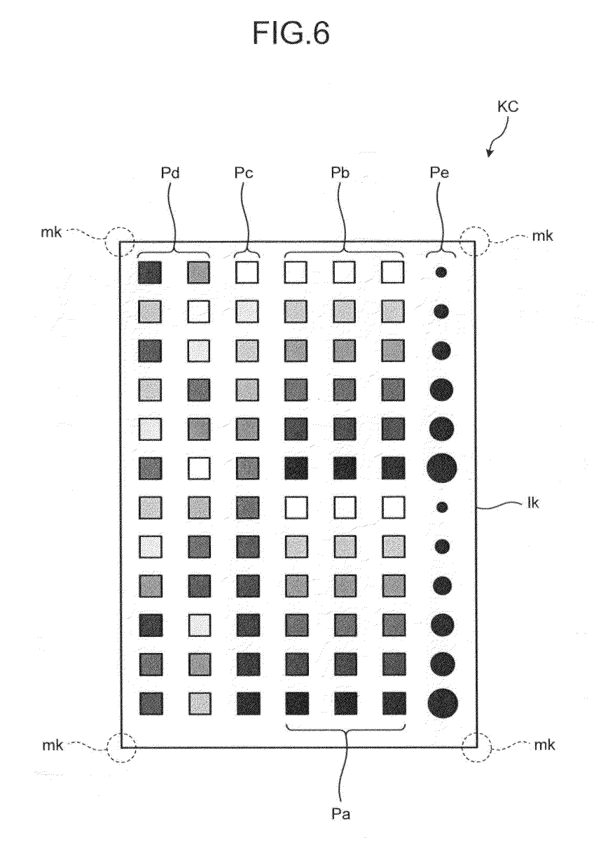

Next, the reference chart KC on the chart board 410 arranged inside the housing 421 of the image capturing unit 42 will be described in detail with reference to FIG. 6. FIG. 6 is diagram illustrating a concrete example of the reference chart KC.

The reference chart KC illustrated in FIG. 6 includes a plurality of colorimetry reference patch rows Pa to Pd in which colorimetrical patches are arranged, a dot diameter measurement pattern row Pe, a distance measurement line lk, and a chart position measurement maker mk.

The reference patch rows Pa to Pd includes a patch row Pa in which patches of primary colors of YMC are arranged in order of gradation, a patch row Pb in which patches of secondary colors of RGB are arranged in order of gradation, a patch row (a achromatic gradation pattern) Pc in which gray scale patches are arranged in order of gradation, and a patch row Pd in which patches of third colors are arranged. The dot diameter measurement pattern row Pe is a pattern row for geometric shape measurement in which circular patterns having different sizes are arranged in order of size.

The distance measurement line lk is formed as a rectangular frame border surrounding a plurality of reference patch rows Pa to Pd and the dot diameter measurement pattern row Pe. The chart position measurement makers mk are markers which are formed at the positions of four corners of the distance measurement line lk and specify respective patch positions. The position of the reference chart KC and the position of each pattern can be specified by specifying the distance measurement line lk and the chart position measurement makers mk of the four corners from the image data of the reference chart KC obtained by image capturing of the image capturing unit 42.

Each of the patches configuring the colorimetry reference patch rows Pa to Pd is used as a reference of a color tone in which an imaging condition under which the image capturing unit 42 performs image capturing is performed.

The configuration of the colorimetry reference patch rows Pa to Pd arranged on the reference chart KC is not limited to the arrangement example illustrated in FIG. 6, and an arbitrary patch row can be used. For example, a patch capable of specifying a color range as widely as possible may be used, or the patch row Pa of the primary color of YMCK or the patch row Pc of the gray scale may be configured with a patch of a colorimetric value of ink used in the image forming apparatus 100. Further, the patch row Pb of the secondary color of RGB of the reference chart KC may be configured with a patch of a colorimetric value capable of producing color by ink used in the image forming apparatus 100, or a reference color chart in which a colorimetric value is decided such as Japan Color may be used.

In the present embodiment, the reference chart KC including the reference patch rows Pa to Pd of a general patch (color chart) form is used, but the reference chart KC needs not be necessarily a form including the reference patch rows Pa to Pd. The reference chart KC may have a configuration in which a plurality of colors usable in colorimetry are arranged such that respective positions can be specified.

The reference chart KC is arranged, on the bottom portion 421a of the housing 421 of the image capturing unit 42, at the position adjacent the opening portion 425, and thus can be captured at the same time as the subject such as the colorimetric target patch CP through the sensor unit 430.

Schematic Configuration of Control Mechanism of Image Forming Apparatus

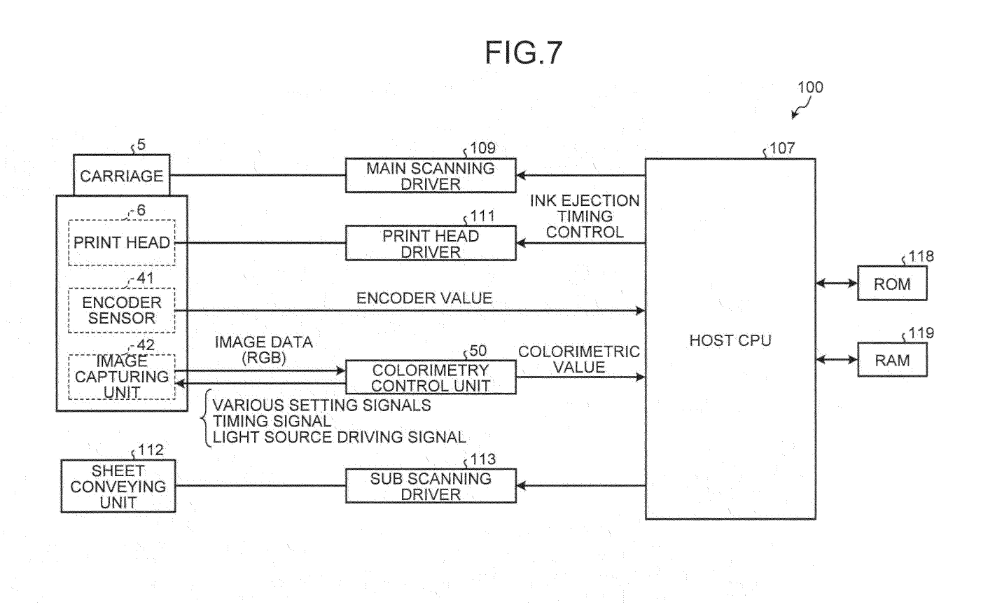

Next, a schematic configuration of a control mechanism of the image forming apparatus 100 according to the present embodiment will be described with reference to FIG. 7. FIG. 7 is a block diagram illustrating of a schematic configuration of a control mechanism of the image forming apparatus 100.

The control mechanism of the image forming apparatus 100 according to the present embodiment includes a host central processing unit (CPU) 107, a read only memory (ROM) 118, a random access memory (RAM) 119, a main scanning driver 109, a print head driver 111, a colorimetry control unit 50, a sheet conveying unit 112, a sub scanning driver 113, the print head 6, the encoder sensor 41, and the image capturing unit 42. The print head 6, the encoder sensor 41, and the image capturing unit 42 are mounted in the carriage 5 as described above.

The host CPU 107 supplies data of an image to be formed on the recording medium P or a driving control signal (a pulse signal) to each driver, and controls the entire image forming apparatus 100 in general. Specifically, the host CPU 107 control driving of the carriage 5 in the main-scanning direction through the main scanning driver 109. Further, the host CPU 107 controls an ejection timing of an ink by the print head 6 through the print head driver 111. Further, the host CPU 107 controls driving of the sheet conveying unit 112 including the carriage roller and the sub-scanning motor through the sub scanning driver 113.

The encoder sensor 41 outputs an encoder value obtained by detecting a mark of the encoder sheet 40 to the host CPU 107. The host CPU 107 controls driving of the carriage 5 in the main-scanning direction based on the encoder value from the encoder sensor 41 through the main scanning driver 109.

The image capturing unit 42 simultaneously captures the colorimetric target patch CP and the reference chart KC with the sensor unit 430 on the chart board 410 arranged inside the housing 421 at the time of colorimetry of the colorimetric target patch CP formed on the recording medium P as described above, and outputs image data including the colorimetric target patch CP and the reference chart KC to the colorimetry control unit 50.

The colorimetry control unit 50 controls an operation of the image capturing unit 42, and acquires image data from the image capturing unit 42. When an adjustment for performing a color adjustment of the image forming apparatus 100 is performed, the colorimetry control unit 50 acquires the image data of the colorimetric target patch CP and the reference chart KC from the image capturing unit 42, and calculates a colorimetric value of (which is a colorimetric value in the standard color space, for example, an L*a*b* value in the CIELAB (CIE 1976 L*a*b*) color space) of the colorimetric target patch CP based on the acquired image data. In the following, for the sake of convenience of description, “L*a*b*” is referred to simply as “Lab”. The colorimetric value of the colorimetric target patch CP calculated by the colorimetry control unit 50 is transferred to the host CPU 107 and used for color adjustment of the image forming apparatus 100. The colorimetry control unit 50 configures the color measuring device together with the image capturing unit 42.

Further, the colorimetry control unit 50 supplies the image capturing unit 42 with various kinds of setting signals and timing signals, a light source driving signal, and the like, and control capturing of an image by the image capturing unit 42. Examples of the various kinds of setting signals include a signal for setting an operation mode of the sensor unit 430 and a signal for setting a shutter speed and an imaging condition such as a gain of AGC. The setting signals are acquired from the host CPU 107 by the colorimetry control unit 50 and supplied to the image capturing unit 42. Further, the timing signal is a signal for controlling a timing of image capturing by the sensor unit 430, and the light source driving signal is a signal for controlling driving of the illumination light source 426 that illuminates the imaging area of the sensor unit 430. The timing signal and the light source driving signal are generated by the colorimetry control unit 50 and then supplied to the image capturing unit 42.

In the present embodiment, the colorimetry control unit 50 is configured separately from the image capturing unit 42, but the colorimetry control unit 50 may be configured to be integrated with the image capturing unit 42. For example, a control circuit functioning as the colorimetry control unit 50 may be mounted in the substrate 423 of the image capturing unit 42. In the case of this configuration, the image capturing unit 42 operating under control by the host CPU 107 functions as the color measuring device according to the present embodiment.

For example, the ROM 118 stores a program representing a process procedure executed by the host CPU 107, a variety of control data, and the like. The RAM 119 is used as a working memory of the host CPU 107.

Configuration of Control Mechanism of Color Measuring Device

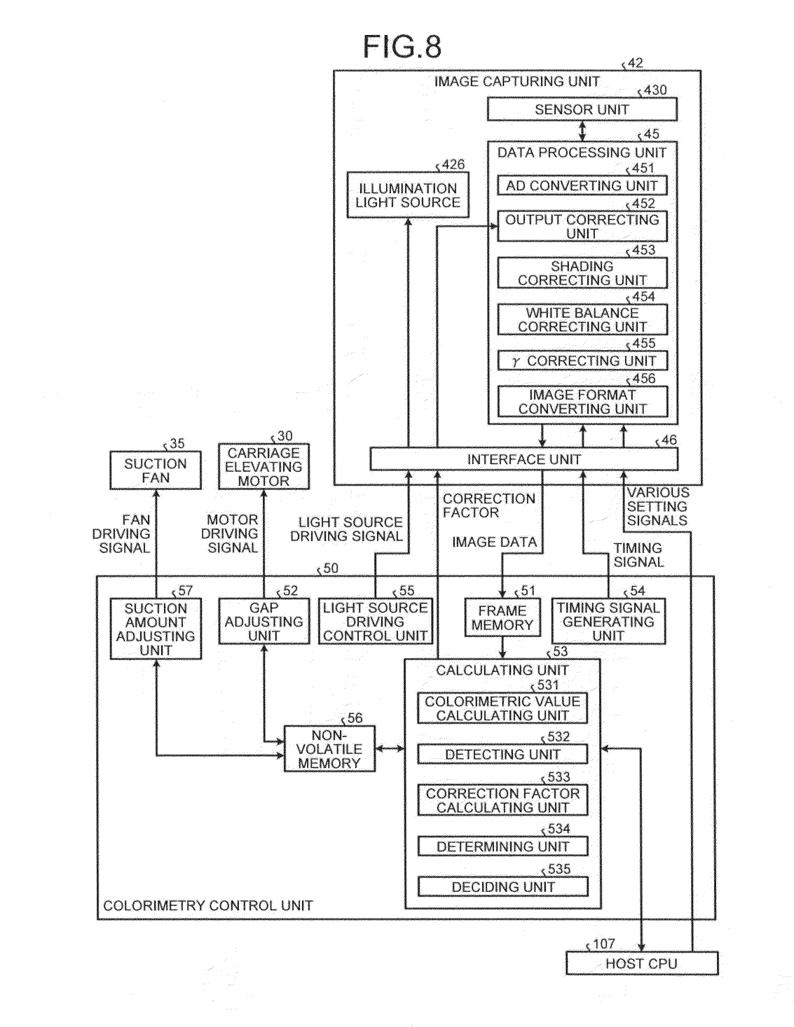

Next, a control mechanism of the color measuring device will be concretely described with reference to FIG. 8. FIG. 8 is a block diagram illustrating a configuration example of a control mechanism of the color measuring device.

The color measuring device includes the image capturing unit 42 and the colorimetry control unit 50. The image capturing unit 42 includes an data processing unit 45 and an interface unit 46 in addition to the sensor unit 430 and the illumination light source 426 described above. The image capturing unit 42 is configured to move (moves up or down) in a direction of getting close to or getting away from the recording medium P together with the carriage 5 as the carriage elevating motor 30 is driven, and thus FIG. 8 illustrates a block diagram of the carriage elevating motor 30 for driving the image capturing unit 42 as described above. Further, the recording medium P on which the subject captured by the image capturing unit 42 is formed is held on the platen plate 22 by suction of a suction fan 35 as described above. FIG. 8 illustrates a block diagram of the suction fan 35 that causes the recording medium P to be held on the platen plate 22.

The data processing unit 45 process image data captured by the sensor unit 430, and includes an AD converting unit 451, an output correcting unit 452, a shading correcting unit 453, a white balance correcting unit 454, a γ correcting unit 455, and an image format converting unit 456. In the present embodiment, the data processing unit 45 is configured separately from the sensor unit 430, but the 2D image sensor 431 of the sensor unit 430 may have a function of the data processing unit 45.

The AD converting unit 451 performs AD conversion on an analog signal of an image output by the sensor unit 430.

The output correcting unit 452 corrects image data (a colorimetric target RGB value) of the colorimetric target patch CP which is a colorimetric target region in image data of the subject and the reference chart KC AD-converted by the AD converting unit 451 using a correction factor calculated in the colorimetry control unit 50 which will be described later. In other words, the output correcting unit 452 corrects the image data (the colorimetric target RGB value) of the colorimetric target patch CP which is the colorimetric target region so that a change in reflected light intensity caused by a change in the gap d between the bottom portion 421a of the housing 421 of the image capturing unit 42 and the recording medium P is offset. The details of a method of calculating the correction factor will be described later.

The shading correcting unit 453 corrects an error of image data caused by uneven illumination of illumination from the illumination light source 426 on the imaging area of the sensor unit 430.

The white balance correcting unit 454 corrects white balance of image data.

The γ correcting unit 455 corrects image data so that linearity of sensitivity of the sensor unit 430 is compensated.

The image format converting unit 456 converts a format of image data into an arbitrary format.

The correction of the image data (the colorimetric target RGB value) of the colorimetric target patch CP by the output correcting unit 452 may be executed before the shading correction by the shading correcting unit 453 or may be executed after the shading correction. Further, a function of the output correcting unit 452 may be given to a calculating unit 53 of the colorimetry control unit 50 which will be described later and executed by the calculating unit 53 of the colorimetry control unit 50.

The interface unit 46 is an interface through which the image capturing unit 42 acquires various setting signals, the timing signal, and the light source driving signal which are transferred from the colorimetry control unit 50, and image data is transferred from the image capturing unit 42 to the colorimetry control unit 50.

The colorimetry control unit 50 includes a frame memory 51, a gap adjusting unit 52, the calculating unit 53, a timing signal generating unit 54, a light source driving control unit 55, a non-volatile memory 56, and a suction amount adjusting unit 57.

The frame memory 51 is a memory that temporarily stores image data transferred from the image capturing unit 42. The image data temporarily stored in the frame memory 51 is transferred to the calculating unit 53. Further, image data configuring one frame is transferred from the image capturing unit 42 to the colorimetry control unit 50 at intervals of predetermined frames as necessary. The frame memory 51 update image data of a frame to be stored each time image data of a new frame is transferred from the image capturing unit 42 to the colorimetry control unit 50.

The gap adjusting unit 52 generates a motor driving signal for driving the carriage elevating motor 30, and supplies the motor driving signal to the carriage elevating motor 30. As the carriage elevating motor 30 operates based on the motor driving signal generated by the gap adjusting unit 52, the carriage 5 and the image capturing unit 42 installed to be fixed to the carriage 5 move up or down to adjust the gap d with the recording medium P. The carriage elevating motor 30 adjusts the position of the image capturing unit 42 to the recording medium P in an optical axis direction of a sensor unit 430.

The timing signal generating unit 54 generates a timing signal for controlling a timing of image capturing performed by the sensor unit 430 of the image capturing unit 42, and supplies the timing signal to the image capturing unit 42.

The light source driving control unit 55 generates a light source driving signal for driving the illumination light source 426 of the image capturing unit 42, and supplies the light source driving signal to the image capturing unit 42.

The suction amount adjusting unit 57 generates a fan driving signal for driving the suction fan 35, and supplies the fan driving signal to the suction fan 35. The suction amount adjusting unit 57 generates a fan driving signal for setting a suction amount for causing the recording medium P to be held on the platen plate 22 to a desired value, and adjusts the suction amount of the suction fan 35.

For example, the gap adjusting unit 52, the timing signal generating unit 54, the light source driving control unit 55, and the suction amount adjusting unit 57 are controlled by the host CPU 107 to execute the above-described operations. Further, the gap adjusting unit 52 and the suction amount adjusting unit 57 can execute the above-described operations based on information stored in the non-volatile memory 56 when information on a target moving-up or down amount of the carriage 5 and the suction amount of the suction fan 35 is stored in the non-volatile memory 56.

The calculating unit 53 executes various kinds of calculations using the image data stored in the frame memory 51 and a variety of information stored in the non-volatile memory 56. The calculating unit 53 includes a colorimetric value calculating unit 531, a detecting unit 532, a correction factor calculating unit 533, a determining unit 534, and a deciding unit 535 as functional components.

The colorimetric value calculating unit 531 calculates the colorimetric value of the colorimetric target patch CP based on the image data of the colorimetric target patch CP and the reference chart KC obtained by image capturing of the image capturing unit 42. The colorimetric value of the colorimetric target patch CP calculated by the colorimetric value calculating unit 531 is transferred to the host CPU 107. Further, the function of the colorimetric value calculating unit 531 may be given to the host CPU 107, and thus the host CPU 107 may calculate the colorimetric value of the colorimetric target patch CP. The details of a concrete example of processing by the colorimetric value calculating unit 531 will be described later.

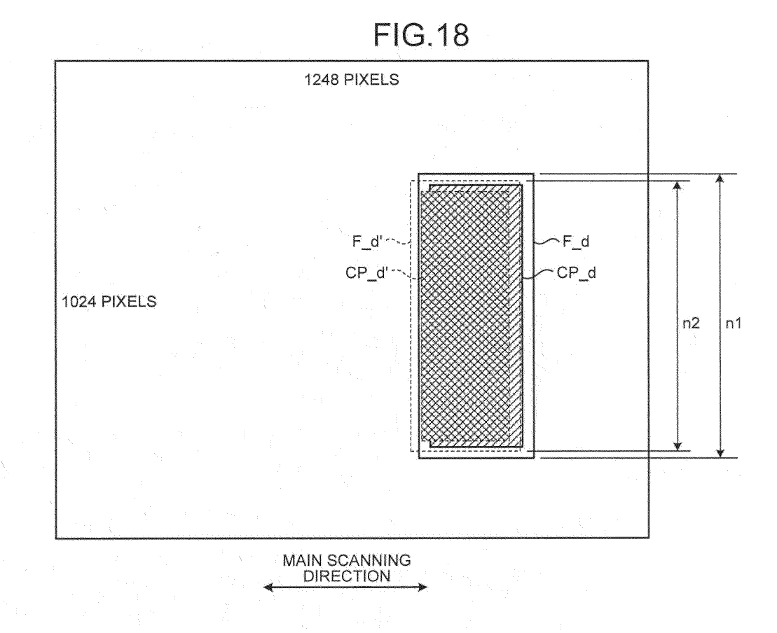

For example, the detecting unit 532, the correction factor calculating unit 533, the determining unit 534, and the deciding unit 535 execute various kinds of processing for suppressing poor colorimetry caused by a change in the gap d or displacement of the recording medium P by a geometric calculation targeted at a pattern image 200 (see FIG. 17) including the colorimetric target patch CP.

The detecting unit 532 detects a distance between predetermined two points from the image data obtained by image capturing performed by the sensor unit 430. Specifically, for example, the detecting unit 532 performs a process of obtaining positions of two points of the pattern image 200 previously decided as a distance measurement target from an image, which includes the colorimetric target patch CP formed on the recording medium P, obtained by capturing of the pattern image 200 and detecting the distance between the two points by a method of counting the number of pixels between the two points.

The correction factor calculating unit 533 obtains a ratio between the distance between the two points detected by the detecting unit 532 and a reference distance, and calculates a correction factor for correcting the image data (the colorimetric target RGB value) of the colorimetric target patch CP in the output correcting unit 452 of the data processing unit 45 according to the ratio. The reference distance refers to a distance between two points measured when the gap d is used as a reference value. For example, the reference distance may be obtained such that the detecting unit 532 detects the distance between the two points of the pattern image 200 captured by the sensor unit 430 when the gap d is set as the reference value in advance, using the same method as described above. For example, the reference distance obtained in advance is stored in the non-volatile memory 56.

For example, the determining unit 534 analyzes the shape of an outer frame F (see FIG. 17) formed to surround the colorimetric target patch CP in an image obtained by capturing of the pattern image 200, determines whether or not the shape of the pattern image 200 has been distorted, and determines the type of shape distortion when it is determined that the shape has been distorted.

The deciding unit 535 determines whether or not the image data (the colorimetric target RGB value) of the colorimetric target patch CP is to be used for a calculation in the colorimetric value calculating unit 531 based on the presence or absence of the shape distortion or the type of the shape distortion determined by the determining unit 534.

The distance between the two points detected by the detecting unit 532, the determination result of the determining unit 534, and the decision of the deciding unit 535 are transferred to the host CPU 107. The host CPU 107 controls an operation of the suction amount adjusting unit 57, an operation of the gap adjusting unit 52, an operation of the colorimetric value calculating unit 531, an operation of the main scanning driver 109 or the sub scanning driver 113, and the like as necessary based on the above information. The functions of the detecting unit 532, the correction factor calculating unit 533, the determining unit 534, and the deciding unit 535 may be given to the host CPU 107, and thus processing of each unit may be executed by the host CPU 107. The details of a concrete example of processing performed by the detecting unit 532, the correction factor calculating unit 533, the determining unit 534, and the deciding unit 535 will be described later.

The non-volatile memory 56 stores a variety of data used in processing by the calculating unit 53 or a variety of data of the processing result. For example, the non-volatile memory 56 stores a memory table Tb1, a reference value linear conversion matrix, a reference inter-RGB linear conversion matrix, and the like (which will be described later) which are used in processing by the colorimetric value calculating unit 531. Further, the non-volatile memory 56 stores a reference distance used to calculate a correction factor of image data by the correction factor calculating unit 533, a correction factor calculation parameter, a distortion pattern used for the determining unit 534 to determine the type of shape distortion, and the like.

Color Measuring Method of Colorimetric Target Patch

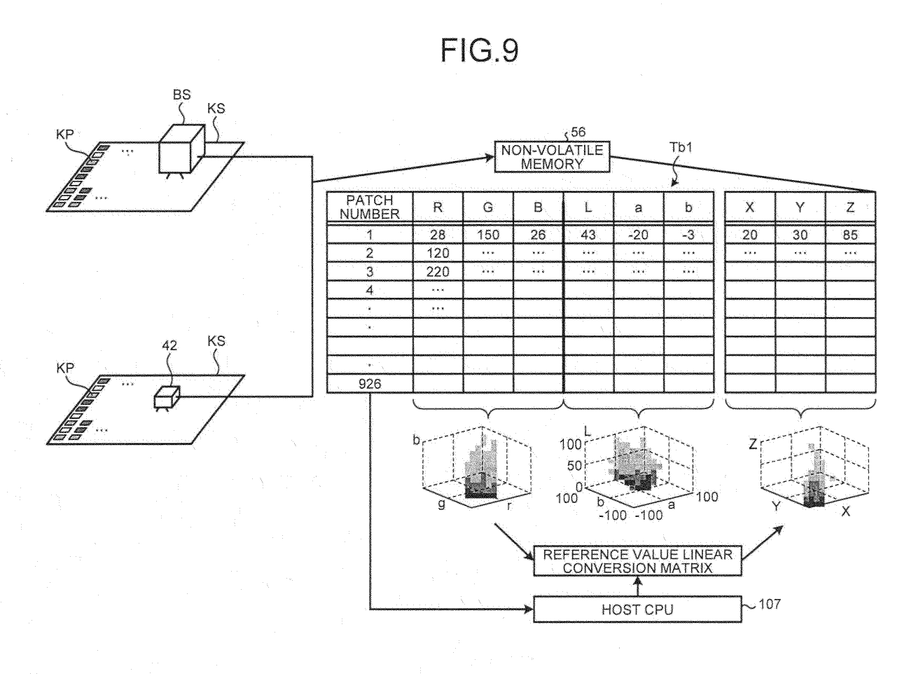

Next, a concrete example of a color measuring method of the colorimetric target patch CP in the image forming apparatus 100 according to the present embodiment will be described in detail with reference to FIGS. 9 to 15. The color measuring method includes preprocessing executed when the image forming apparatus 100 is in an initial state (when it is in an initial state by manufacturing, over fall, or the like) and a colorimetry process executed when an adjustment for performing a color adjustment of the image forming apparatus 100 is performed. The following color measuring method is an example, and the present invention is not limited to the following method.

FIG. 9 is a diagram for describing processing of acquiring a reference colorimetric value and a reference RGB value and processing of generating a reference value linear conversion matrix. The processing illustrated in FIG. 9 is executed as preprocessing. In the preprocessing, a reference sheet KS in which a plurality of reference patches KP are arranged and formed is used. The reference patch KP of the reference sheet KS is the same as a patch of the reference chart KC of the image capturing unit 42.

First of all, at least one (both of the Lab value and the XYZ value in the example of FIG. 9) of an Lab value and an XYZ value which are colorimetric values of the plurality of reference patches KP of the reference sheet KS is stored in the memory table Tb1 of the non-volatile memory 56 in associated with a patch number. The colorimetric value of the reference patch KC is a value obtained in advance by colorimetry using a spectroscope BS. When a colorimetric value of the reference patch KP is given, the value is preferably used. The colorimetric value of the reference patch KP stored in the memory table Tb1 of the non-volatile memory 56 is referred to as a “reference colorimetric value”.

Next, as the reference sheet KS is set on the platen plate 22 and movement of the carriage 5 is controlled, the plurality of reference patches KP of the reference sheet KS as subjects are subjected to image capturing by the image capturing unit 42. Then, the RGB value of the reference patch KP obtained by image capturing by the image capturing unit 42 is stored in the memory table Tb1 of the non-volatile memory 56 in association with the patch number. In other words, the memory table Tb1 of the non-volatile memory 56 stores the colorimetric values and the RGB values of the plurality of reference patches KP arranged and formed on the reference sheet KS in association with the patch numbers of the reference patches KP. The RGB value of the reference patch KC stored in the memory table Tb1 of the non-volatile memory 56 is referred to as a “reference RGB value”. The reference RGB value is a value in which a characteristic of the image capturing unit 42 is reflected.

When the reference colorimetric value and the reference RGB value of the reference patch KP are stored in the memory table Tb1 of the non-volatile memory 56, the host CPU 107 of the image forming apparatus 100 generates the reference value linear conversion matrix for converting the XYZ value which is the reference colorimetric value of the same patch number and the reference RGB value into each other, and then stores the reference value linear conversion matrix in the non-volatile memory 56. When only the Lab value is stored in the memory table Tb1 of the non-volatile memory 56 as the reference colorimetric value, the Lab value may be converted into the XYZ value using a well-known conversion equation for converting the Lab value into the XYZ value, and then the reference value linear conversion matrix may be generated.

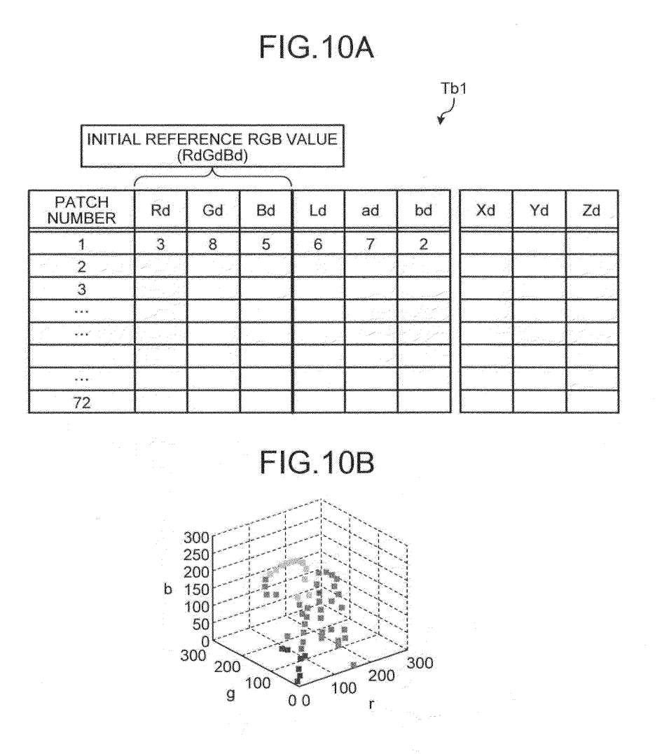

Further, when the image capturing unit 42 captures the plurality of reference patches KP of the reference sheet KS, the reference chart KC disposed in the image capturing unit 42 is simultaneously captured. The RGB value of each patch of the reference chart KC obtained by the image capturing is also stored in the memory table Tb1 of the non-volatile memory 56 in association with the patch number. The RGB value of the patch of the reference chart KC stored in the memory table Tb1 of the non-volatile memory 56 by the preprocessing is referred to as an “initial reference RGB value”. FIGS. 10A and 10B illustrate an example of the initial reference RGB value. FIG. 10A illustrates an aspect in which the initial reference RGB value (R_{d}G_{d}B_{d}) is stored in the memory table Tb1, and an initial reference RGB value (R_{d}G_{d}B_{d}) is stored in association with an initial reference Lab value (L_{d}a_{d}b_{d}) obtained by converting the initial reference RGB value (R_{d}G_{d}B_{d}) into the Lab value and an initial reference XYZ value (X_{d}Y_{d}Z_{d}) obtained by converting the initial reference RGB value (R_{d}G_{d}B_{d}) into the XYZ value. FIG. 10B is a scatter diagram plotting the initial reference RGB value of each patch of the reference chart KC.

After the initial processing ends, in the image forming apparatus 100, based on image data input from the outside, a print setting, and the like, the host CPU 107 performs main-scanning movement control of the carriage 5, conveying control of the recording medium P by the sheet conveying unit 112, and driving control of the print head 6 to intermittently convey the recording medium P, and controls ejection of ink from the print head 6 to output an image onto the recording medium P. At this time, the ejection amount of the ink from the print head 6 may change according to a characteristic specific to a device, a temporal change, or the like, and when the ejection amount of the ink changes, an image is formed in color different from color of an image desired by a user, and thus color reproducibility degrades. In this regard, the image forming apparatus 100 executes the colorimetry process for obtaining the colorimetric value of the colorimetric target patch CP at a predetermined timing at which color adjustment is performed. Then, the color adjustment is performed based on the colorimetric value obtained by the colorimetry process, and thus color reproducibility is improved.

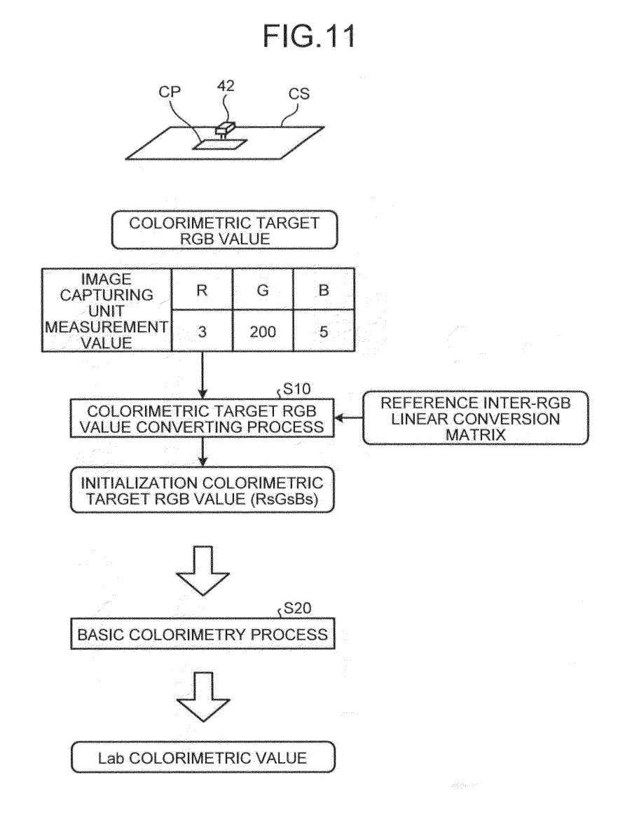

FIG. 11 is a diagram for describing an outline of the colorimetry process. First of all, the image forming apparatus 100 ejects ink from the print head 6 onto the recording medium P set on the platen plate 22 when an adjustment for performing a color adjustment is performed to form the colorimetric target patch CP. Hereinafter, the recording medium P on which the colorimetric target patch CP is formed is referred to as an “adjustment sheet CS”. The colorimetric target patch CP in which output characteristics at the time of adjustment of the image forming apparatus 100, that is, output characteristics of the print head 6 are reflected is formed on the adjustment sheet CS. The color patch data of the colorimetric target patch CP is stored in the non-volatile memory 56 or the like in advance.

Next, in the image forming apparatus 100, the adjustment sheet CS is set on the platen plate 22 as illustrated in FIG. 11, but in a state in which the adjustment sheet CS is not discharged at the stage at which the adjustment sheet CS is generated but held on the platen plate 22, movement of the carriage 5 is controlled to move the image capturing unit 42 to the position facing the colorimetric target patch CP formed on the adjustment sheet CS on the platen plate 22. Then, the image capturing unit 42 captures the colorimetric target patch CP while capturing a patch of the reference chart KC disposed in the image capturing unit 42. The image data of the patch of the colorimetric target patch CP and the reference chart KC simultaneously captured by the image capturing unit 42 is subjected to necessary image processing in the data processing unit 45, and then transferred to the colorimetry control unit 50, and temporarily stored in the frame memory 51. In the image data simultaneously captured by the image capturing unit 42 and temporarily stored in the frame memory 51, image data (the RGB value) of the colorimetric target patch CP is referred to as a “colorimetric target RGB value”, and image data (the RGB value) of the patch of the reference chart KC is referred to as a “colorimetry reference RGB value (R_{ds}G_{ds}B_{ds})”. The “colorimetry reference RGB value (R_{ds}GₐₛB_{ds})” is stored in the non-volatile memory 56.

The colorimetric value calculating unit 531 of the colorimetry control unit 50 performs processing of converting the colorimetric target RGB value temporarily stored in the frame memory 51 into an initialization colorimetric target RGB value (RₛGₛBₛ) using the reference inter-RGB linear conversion matrix which will be described later (step S10). The initialization colorimetric target RGB value (RₛGₛBₛ) is one in which influence of a temporal change in the imaging condition of the image capturing unit 42 such as a temporal change of the illumination light source 426 or a temporal change of the 2D image sensor 431 which occurs during a period of time from the initial state at which the preprocessing is performed to the time of adjustment at which the colorimetry process is performed is removed from the colorimetric target RGB value.

Thereafter, the colorimetric value calculating unit 531 executes a basic colorimetry process (which will be described later) on the initialization colorimetric target RGB value (RₛGₛBₛ) converted from the colorimetric target RGB value (step S20), and acquires the Lab value as the colorimetric value of the colorimetric target patch CP.

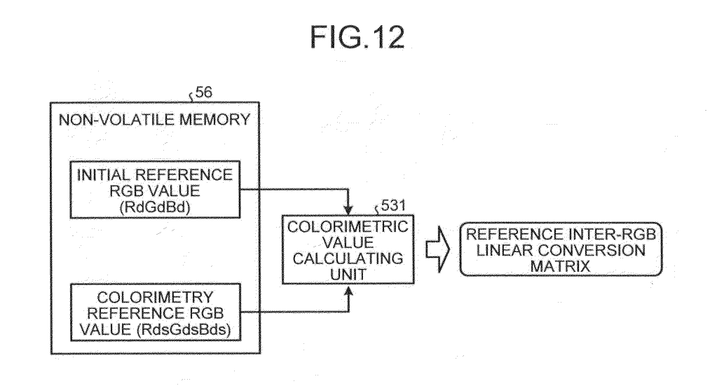

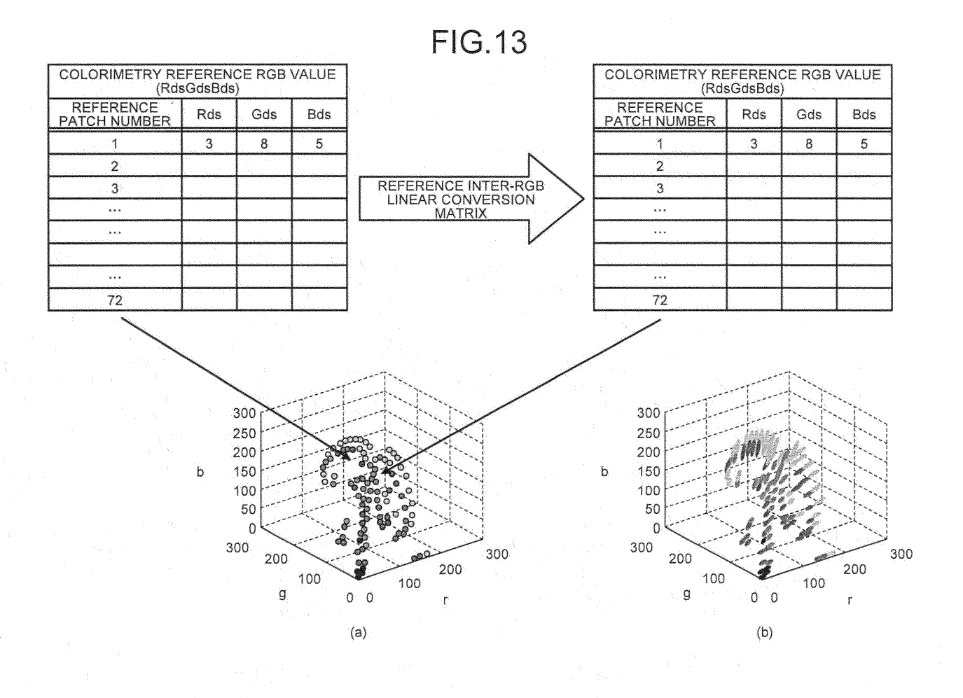

FIG. 12 is a diagram for describing processing of generating the reference inter-RGB linear conversion matrix, and FIG. 13 is a diagram illustrating a relation between the initial reference RGB value and the colorimetry reference RGB value. The colorimetric value calculating unit 531 generates the reference inter-RGB linear conversion matrix used for the conversion before performing processing (step S10) of converting the colorimetric target RGB value into the initialization colorimetric target RGB value (RₛGₛBₛ). In other words, the colorimetric value calculating unit 531 reads the initial reference RGB value (R_{d}G_{d}B_{d}) obtained in the preprocessing when the image forming apparatus 100 is in the initial state and the colorimetry reference RGB value (R_{ds}G_{ds}B_{ds}) obtained at the time of adjustment from the non-volatile memory 56, and generates the reference inter-RGB linear conversion matrix for converting the colorimetry reference RGB value RdsGdsBds into the initial reference RGB value R_{d}G_{d}B_{d} as illustrated in FIG. 12. Then, the colorimetric value calculating unit 531 stores the generated reference inter-RGB linear conversion matrix in the non-volatile memory 56.

In FIG. 13, a point indicated by a decolorized point in (a) of FIG. 13 is a point to plot the initial reference RGB value R_{d}G_{d}B_{d} in the rgb space, and a fill point is a point to plot the colorimetry reference RGB value R_{ds}G_{ds}B_{ds} in the rgb space. As can be seen from (a) of FIG. 13, the value of the colorimetry reference RGB value R_{ds}G_{ds}B_{ds} changes from the value of the initial reference RGB value R_{d}G_{d}B_{d}, and the change direction in the rgb space is almost the same as illustrated in (b) of FIG. 13, but a deviation direction differs according to a hue. As described above, even when the patch of the same reference chart KC is captured, the RGB value changes due to the temporal change of the illumination light source 426, the temporal change of the 2D image sensor 431, and the like.

As described above, when the colorimetric value is obtained using the colorimetric target RGB value obtained by capturing the colorimetric target patch CP in a state in which the RGB value obtained by image capturing by the image capturing unit 42 has changed, an error may occur in the colorimetric value by a change amount. In this regard, in the image forming apparatus 100 according to the present embodiment, the reference inter-RGB linear conversion matrix of converting the colorimetry reference RGB value R_{ds}G_{ds}B_{ds} into the initial reference RGB value R_{d}G_{d}B_{d} is obtained using an estimation technique such as the least square method between the initial reference RGB value R_{d}G_{d}B_{d} and the colorimetry reference RGB value R_{ds}G_{ds}B_{ds}, the colorimetric target RGB value obtained by capturing the colorimetric target patch CP through the image capturing unit 42 is converted into an initialization colorimetric target RGB value RₛGₛBₛ using the reference inter-RGB linear conversion matrix, and the basic colorimetry process which will be described later is executed on the converted initialization colorimetric target RGB value RₛGₛBₛ. Thus, the colorimetric value of the colorimetric target patch CP can be acquired with a high degree of accuracy.

The reference inter-RGB linear conversion matrix may be a high-order non-linear matrix as well as a primary non-linear matrix, and when non-linearity between the rgb space and the XYZ space is high, the accuracy of conversion can be improved by using a high-order matrix.

The colorimetric value calculating unit 531 converts the colorimetric target RGB value obtained by capturing the colorimetric target patch CP into the initialization colorimetric target RGB value (RₛGₛBₛ) using the reference inter-RGB linear conversion matrix (step S10), and then performs the basic colorimetry process of step S20 on the initialization colorimetric target RGB value (RₛGₛBₛ) as described above.

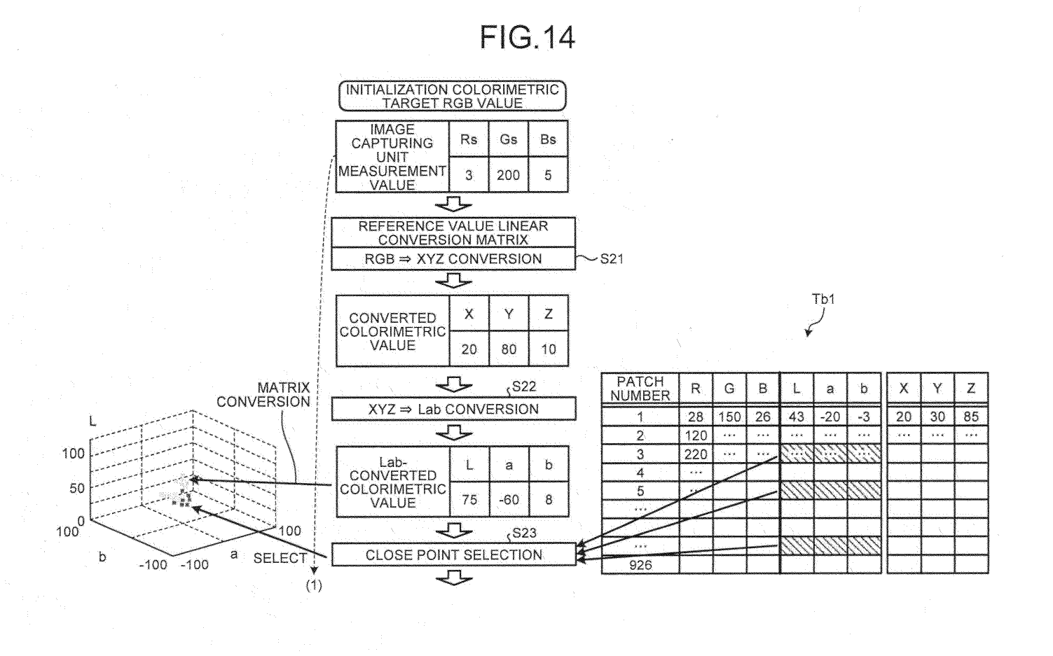

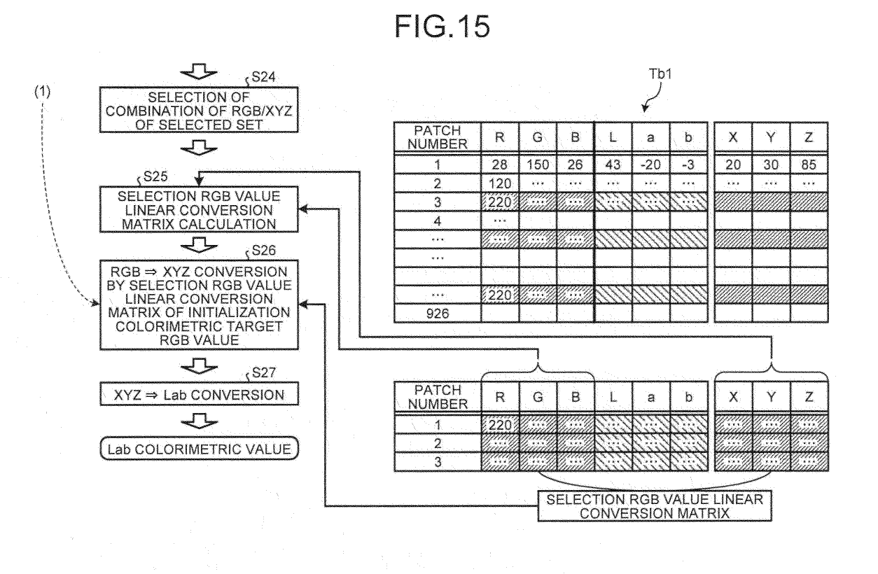

FIGS. 14 and 15 are diagrams for describing the basic colorimetry process. First of all, the colorimetric value calculating unit 531 reads the reference value linear conversion matrix which is generated in the preprocessing and then stored in the non-volatile memory 56, converts the initialization colorimetric target RGB value (RₛGₛBₛ) into a first XYZ value using the reference value linear conversion matrix, and stores the first XYZ value in the non-volatile memory 56 (step S21). FIG. 14 illustrates an example in which an initialization colorimetric target RGB value (3, 200, 5) is converted into a first XYZ value (20, 80, 10) by the reference value linear conversion matrix.

Next, the colorimetric value calculating unit 531 converts the first XYZ value converted from the initialization colorimetric target RGB value (RₛGₛBₛ) in step S21 into a first Lab value using a well-known conversion equation, and stores the first Lab value in the non-volatile memory 56 (step S22). FIG. 14 illustrates an example in which a first XYZ value (20, 80, 10) is converted into a first Lab value (75, −60, 8) by a well-known conversion equation.

Next, the colorimetric value calculating unit 531 searches for a plurality of reference colorimetric values (Lab values) stored in the memory table Tb1 of the non-volatile memory 56 in the preprocessing, and selects a set of a plurality of patches (near color patches) having the reference colorimetric value (the Lab value) that is close in distance to the first Lab value in the Lab space among the reference colorimetric values (the Lab values) (step S23). For example, a method of calculating the distance from the first Lab value on all reference colorimetric values (the Lab values) stored in the memory table Tb1, and selecting a plurality of patches having the Lab values (the hatched Lab values in FIG. 14) that are close in distance to the first Lab value can be used as a method of selecting a patch whose distance is close.

Next, as illustrated in FIG. 15, the colorimetric value calculating unit 531 extracts the RGB values (the reference RGB values) and the XYZ values which are associated with the Lab values on each of the near color patches selected in step S23 with reference to the memory table Tb1, and selects a combination of the RGB value and the XYZ value from the plurality of RGB values and XYZ values (step S24). Then, the colorimetric value calculating unit 531 obtains a selection RGB value linear conversion matrix for converting the RGB values of the selected combination (the selection set) into the XYZ values using the least square method or the like, and stores the obtained selection RGB value linear conversion matrix in the non-volatile memory 56 (step S25).

Next, the colorimetric value calculating unit 531 converts the initialization colorimetric target RGB value (RₛGₛBₛ) into a second XYZ value using the selection RGB value linear conversion matrix generated in step S25 (step S26). Further, the colorimetric value calculating unit 531 converts the second XYZ value obtained in step S26 into a second Lab value using a well-known conversion equation (step S27), and uses the obtained second Lab value as the final colorimetric value of the colorimetric target patch CP. The image forming apparatus 100 improves the color reproducibility by performing the color adjustment based on the colorimetric value obtained by the colorimetry process.

Method of Correcting Colorimetric Target RGB Value

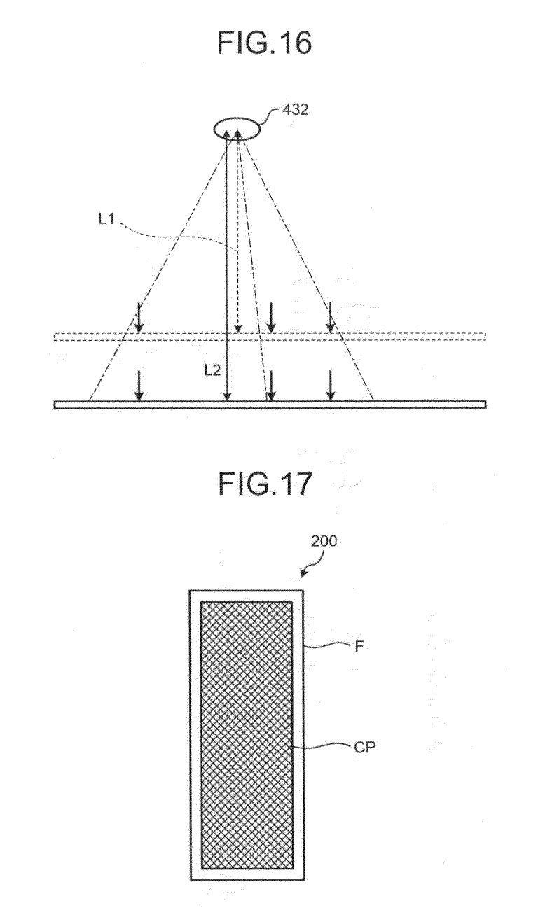

Next, a concrete example of a method of correcting the colorimetric target RGB value for offsetting a change in reflected light intensity occurring due to a change in the gap d will be described with reference to FIGS. 16 to 21.

As described above, the image capturing unit 42 is configured to capture of an image of a subject in a state in which the bottom portion 421a of the housing 421 faces the recording medium P on which the subject is formed with the gap d therebetween. When the image forming apparatus 100 is in the normal operation mode, the gap d is a predetermined reference value d1 (for example, 1.4 mm). However, when a thick sheet, a coated sheet, a matte film, or the like is used as the recording medium P, if the carriage 5 is at the position at which the gap d is equal to d1, the recording medium P is likely to come into contact with the print head 6 and damages the print head 6. In this regard, in the image forming apparatus 100 according to the present embodiment, an operation mode called a “thick sheet mode” or a “rubbing avoiding mode” is provided, and when this operation mode is selected, the carriage elevating motor 30 is driven to lift the carriage 5. In this case, the image capturing unit 42 installed to be fixed to the carriage 5 moves in a direction getting away from the recording medium P, and thus the gap d has a value d2 (for example, d1+1 mm or d1+2 mm) larger than d1. Further, the moving-up or down of the carriage 5 is controlled by a driving time of the carriage elevating motor 30, and thus an error is about ±0.2 mm and relatively large.

When the gap d changes from d1 to d2, the distance from the sensor unit 430 and the illumination light source 426 to the subject increases, the reflected light intensity of the subject decreases, and thus the image data of the subject output from the sensor unit 430 is influenced. Further, when the colorimetric value is calculated based on the image data (the colorimetric target RGB value) of the colorimetric target region (the colorimetric target patch CP) of the subject in this state, an error occurs in the colorimetric value.

In this regard, the image forming apparatus 100 according to the present embodiment removes influence of a change in reflected light intensity occurring due to a change in the gap d by feeding the correction factor calculated by the correction factor calculating unit 533 disposed in the colorimetry control unit 50 back to the data processing unit 45 of the image capturing unit 42 and correcting the image data (the colorimetric target RGB value) of the colorimetric target patch CP using the correction factor through the output correcting unit 452 disposed in the data processing unit 45. Further, the colorimetric value calculating unit 531 of the colorimetry control unit 50 calculates an accurate colorimetric value by calculating the colorimetric value of the colorimetric target patch CP using the corrected colorimetric RGB value.

The correction factor calculating unit 533 calculates the correction factor using the distance between the two points of the pattern image 200 detected by the detecting unit 532 and the reference distance previously stored in the non-volatile memory 56 as described above. Next, a concrete example of processing performed by the detecting unit 532 and the correction factor calculating unit 533 will be described.

FIG. 16 is a diagram modeling a change in an optical path length and a change in a position of a subject in an image with a change in the gap d. When the gap d changes from d1 to d2, the optical path length between the imaging lens 432 of the sensor unit 430 and the subject changes from L1 to L2. Here, if the subject with the same size is captured when the gap d is d1 and when the gap d is d2, the image size of the subject on an image captured when the gap d is d2 is smaller than the size of the subject on an image captured when the gap d is d1 by a degree by which the optical path length changes from L1 to L2. Using this feature, a change in the gap d can be obtained from a change in the image size of the subject.

When an adjustment for performing a color adjustment is performed, the image forming apparatus 100 according to the present embodiment forms the pattern image 200 including the colorimetric target patch CP on the recording medium P as the subject, and obtains a change in the image size of the subject with a change in the gap d using the geometric shape of the image obtained by capturing the pattern image 200 through the image capturing unit 42. FIG. 17 is a diagram illustrating an example of the pattern image 200 formed on the recording medium P by the image forming apparatus 100. The pattern image 200 illustrated in FIG. 17 includes the colorimetric target patch CP and the outer frame F formed to surround the colorimetric target patch CP. The colorimetric target patch CP is a rectangular patch, and the outer frame F is a rectangular frame imitating the shape of the colorimetric target patch CP.

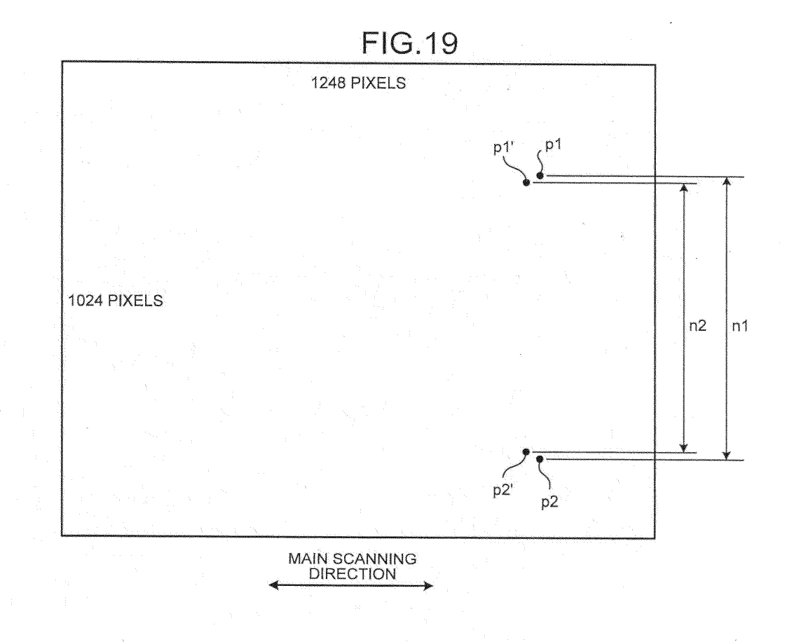

FIG. 18 is a diagram illustrating an image obtained by capturing the pattern image 200 illustrated in FIG. 17 through the image capturing unit 42, and illustrates a change in an image forming position of the pattern image 200 on the 2D image sensor 431 of the sensor unit 430 when the gap d is d1 and when the gap d is d2. Compared to an image CP_d of the colorimetric target patch CP and an image F_d of the outer frame F when the gap d is d1, as the optical path length is increased, an image CP_d′ of the colorimetric target patch CP and an image F_d′ of the outer frame F when the gap d is increased to d2 are reduced in size, and the image forming position is deviated. At this time, a reduction ratio of an image is in proportion to the amount of change in the optical path length. The amount of change in the optical path length is equal to the amount of change in the gap d. Thus, the amount of change in the gap d can be obtained by obtaining the reduction ratio of the image.

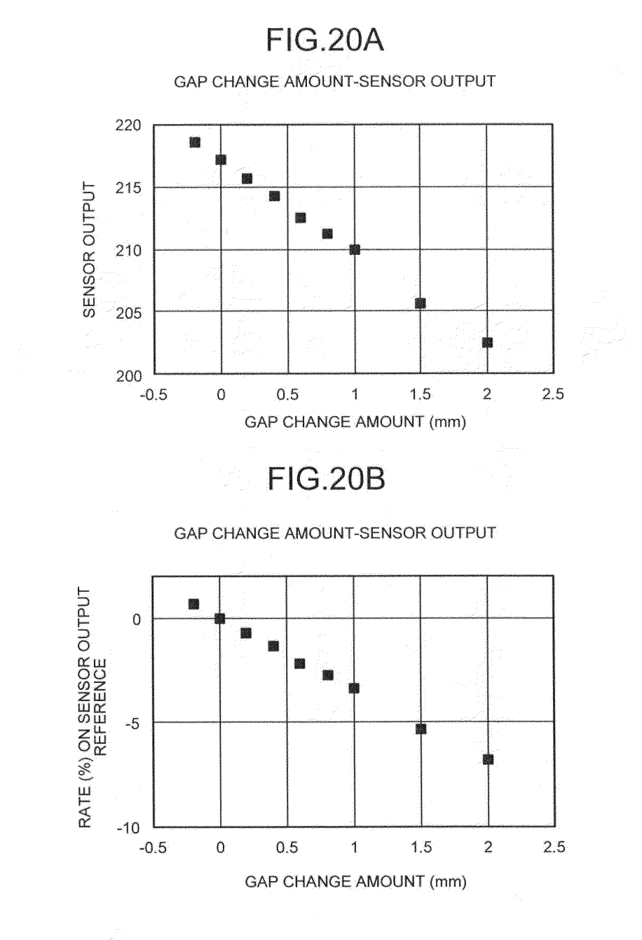

FIG. 19 illustrates a point p1 of an upper right corner and a point p2 of a lower right corner which are extracted from the image F_d of the outer frame F illustrated in FIG. 18, and a point p1′ of an upper right corner and a point p2′ of a lower right corner which are extracted from the image F_d′ of the outer frame F. As the gap d is increased from d1 to d2 and so the optical path length increases, a distance n2 on an image between p1′ and p2′ is reduced to be smaller than a distance n1 on an image between p1 and p2. The reduction ratio of the distance n2 to the distance n1 corresponds to the reduction ratio of the image F_d′ of the outer frame F to the image F_d of the outer frame F. The optical path length L2 (see FIG. 16) when the gap d is d2 can be obtained using the distance n2 and the distance n1 as follows.

L2=L1×n1/n2

Here, L1 is the optical path length when the gap d is the reference value d1, and is a given value. Thus, the value of L2 can be obtained from the ratio (n1/n2) of n1 to n2, and the amount of change from the reference value d1 of the gap d can be obtained from “L2−L1”.

In the present embodiment, the pattern image 200 is captured through the image capturing unit 42 in advance in a state in which the gap d is the reference value d1, the distance n1 is obtained from the obtained image by counting the number of pixels between p1 and p2 in the image F_d of the outer frame F, and the distance n1 is stored in the non-volatile memory 56 as the reference distance. Then, when an adjustment for performing a color adjustment is performed, the detecting unit 532 extracts the same points as p1 and p2 from an image obtained by capturing the pattern image 200 through the image capturing unit 42, and the distance is obtained by counting the number of pixels between the points. For example, when the gap d is d2, p1′ and p2′ are extracted from the image F_d′ of the outer frame F, and the distance n2 is detected.

Further, in the present embodiment, the pattern image 200 in which the colorimetric target patch CP is combined with the outer frame F surrounding the colorimetric target patch CP is used, but the pattern image 200 may have any form as long as the pattern image 200 includes the colorimetric target patch CP and is configured so that the distance between two points on an image can be detected. For example, the pattern image 200 having a distance measurement pattern such as a key type, a cross type, a double line, a dotted line, or the like in addition to the colorimetric target patch CP may be used. Further, the pattern image 200 may be configured only with the colorimetric target patch CP, and the distance between the two points may be detected using a contour of the colorimetric target patch CP.

The correction factor calculating unit 533 calculates the correction factor used to correct the image data (the colorimetric target RGB value) of the colorimetric target patch CP in the output correcting unit 452 of the data processing unit 45 according to the amount of change in the gap d obtained from the ratio of the distance between the two points (the distance n2 when the gap d is d2) detected by the detecting unit 532 and the reference distance n1.

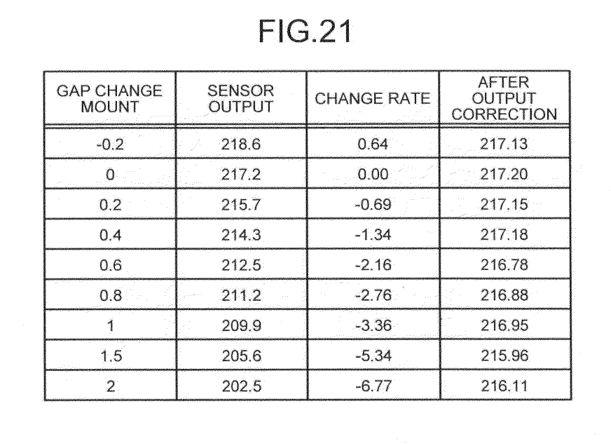

FIGS. 20A and 20B illustrate examples of a relation between the amount of change in the gap d (a gap change amount) from the reference value d1 and an output from (a sensor output) the 2D image sensor 431 of the sensor unit 430. FIG. 20A illustrates a change in a sensor output corresponding to the gap change amount, and FIG. 20B illustrates a change in a rate on a sensor output reference with respect to the gap change amount when a sensor output when the gap d is the reference value d1 (the gap change amount is 0) is used as a reference. Based on the relation between the gap change amount and the sensor output illustrated in FIGS. 20A and 20B, the correction factor calculation parameter for calculating the correction factor in the output correcting unit 452 which corresponds to the gap change amount can be obtained.

The relation between the gap change amount and the sensor output illustrated in FIGS. 20A and 20B changes according to an arrangement or a characteristic of the illumination light source 426 of the image capturing unit 42 disposed in the image forming apparatus 100. In this regard, for example, in the manufacturing process of the image forming apparatus 100, actually, the relation between the gap change amount and the sensor output illustrated in FIGS. 20A and 20B is obtained by obtaining output of the 2D image sensor 431 of the sensor unit 430 while changing the gap d from the reference value d1 by driving of the carriage elevating motor 30. Then, the correction factor calculation parameter is obtained based on the relation between the gap change amount and the sensor output, and then stored in the non-volatile memory 56. In the example illustrated in FIGS. 20A and 20B, when the gap change amount is 1 mm, the sensor output is reduced by 3.36% (see FIG. 20B), and 3.36%/mm is stored in the non-volatile memory 56 as the correction factor calculation parameter. Here, the description has been made in connection with the example in which the linear correction corresponding to the gap change amount is performed by the output correcting unit 452, but correction using a correction table or correction using a high-order function may be performed. In this case, a correction table or a high-order function obtained from the relation between the gap change amount and the sensor output is stored in the non-volatile memory 56 as the correction factor calculation parameter.

When the detecting unit 532 detects the distance between the two points from the image obtained by capturing the pattern image 200 through the image capturing unit 42, the correction factor calculating unit 533 reads the reference distance and the correction factor calculation parameter stored in the non-volatile memory 56. Then, the correction factor calculating unit 533 obtains the gap change amount based on the ratio of the distance between the two points detected by the detecting unit 532 to the reference distance. Further, the correction factor calculating unit 533 obtains the correction factor for correcting the image data (the colorimetric target RGB value) of the colorimetric target patch CP in the output correcting unit 452 of the data processing unit 45 based on the obtained gap change amount and the correction factor calculation parameter. For example, when the correction factor calculation parameter is 3.36%/mm, if the gap change amount is 1 mm, the correction factor is 3.36%, and if the gap change amount is 2 mm, the correction factor is 6.72%.

The output correcting unit 452 of the data processing unit 45 corrects the image data (the colorimetric target RGB value) of the colorimetric target patch CP which is the colorimetric target region among pieces of image data which is output from the 2D image sensor 431 of the sensor unit 430 and subjected to AD conversion by the AD converting unit 451 using the correction factor calculated by the correction factor calculating unit 533.

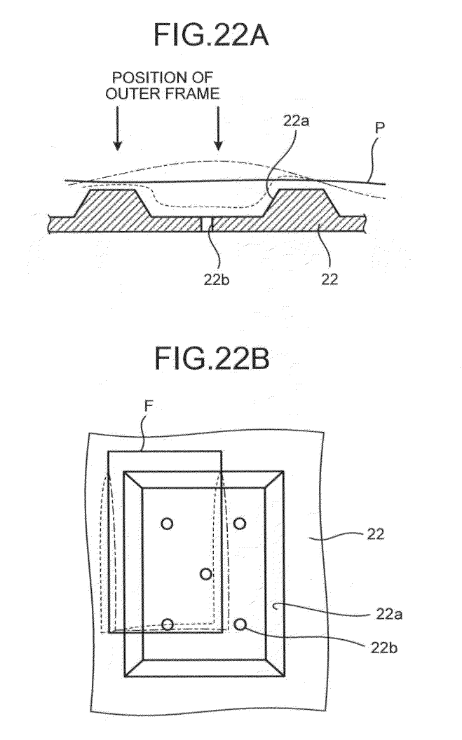

FIG. 21 is a diagram illustrating an example of a relation among the gap change amount, a sensor output before correction, and a value after output correction. The example of FIG. 21 is an example in which the correction factor calculation parameter is 3.36%/mm, and the value after output correction is obtained by “sensor output×(1+gap change amount×0.0336)”. As can be seen from FIG. 21, even when the gap d changes from the reference value d1, the image data (the colorimetric target RGB value) of the colorimetric target patch CP can become almost uniform through correction by the output correcting unit 452. In other words, through correction of the output correcting unit 452, fluctuation in a sensor output according to a change in reflected light intensity occurring due to a change in the gap d can be canceled, and the stable colorimetric target RGB value can be obtained.

Modification of Method of Correcting Colorimetric Target RGB Value

In the above description, the detecting unit 532 detects the distance between the two points from the image data obtained by capturing the pattern image 200 including the colorimetric target patch CP through the sensor unit 430. However, the detecting unit 532 may detect the distance between the two points from image data that does not include the colorimetric target patch CP captured by the sensor unit 430. In other words, the sensor unit 30 may be configured not only to capture the colorimetric target patch CP on the recording medium P but also to capture a predetermined position at which the colorimetric target patch CP on the recording medium P is not included, and the detecting unit 532 may detect the distance between the two points formed at the predetermined position.

The distance between the two points detected by the detecting unit 532 is used to calculate the correction factor for correcting the image data (the colorimetric target RGB value) of the colorimetric target patch CP according to the amount of change from the reference value of the gap d as described above. Here, since the change in the gap d usually occurs when the recording medium P on which the colorimetric target patch CP is formed is changed to a different thickness, in the case of the same recording medium P, the difference in the gap d with the image capturing unit 42 rarely occurs between the position at which the colorimetric target patch CP is formed and the position at which the colorimetric target patch CP is not formed. Thus, even when the detecting unit 532 detects the distance between the two points at the predetermined position at which the colorimetric target patch CP is not included, and the image data (the colorimetric target RGB value) of the colorimetric target patch CP is corrected using the correction factor according to the ratio of the distance between the two points to the reference distance, image data of the colorimetric target patch CP can be appropriately corrected.

Further, when the difference in the gap d occurs in units of a plurality of regions of the same recording medium P, the distance between the two points may be detected in units of regions, the correction factor according to the ratio of the distance between the two points to the reference distance may be calculated in units of regions, and the image data (the colorimetric target RGB value) of the colorimetric target patch CP included in each region may be corrected using the correction factor calculated in units of regions.

In the above description, the reference distance which is the distance between the two points when the gap d is the reference value is measured in advance and then stored in the non-volatile memory 56 or the like. However, when portions (for example, two points used as a reference) for acquiring the reference distance are formed on the reference chart KC captured together with the colorimetric target patch CP by the sensor unit 430, the reference distance can be acquired from the reference chart KC captured together with the colorimetric target patch CP each time the sensor unit 430 captures the colorimetric target patch CP.

Since the reference chart KC is disposed in the housing 421 of the image capturing unit 42 as described above, a positional relation on the sensor unit 430 or the illumination light source 426 is always maintained constant. For this reason, even when the gap d changes, an image of the reference chart KC captured by the sensor unit 30 does not change. Thus, even when the reference distance is acquired from the image of the reference chart KC captured at the same time each time the sensor unit 30 captures the colorimetric target patch CP, and the image data (the colorimetric target RGB value) of the colorimetric target patch CP is corrected using the correction factor according to the ratio of the distance between the two points detected by the detecting unit 532 to the reference distance, the image data of the colorimetric target patch CP can be appropriately corrected.

Shape Distortion of Pattern Image

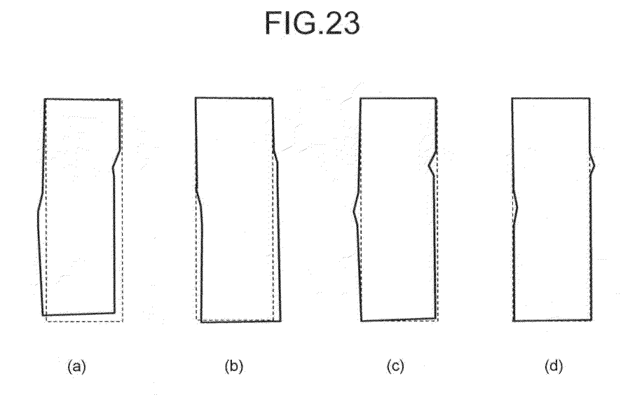

Next, a concrete example of processing when there is shape distortion in the image obtained by capturing the pattern image 200 through the image capturing unit 42 will be described with reference to FIGS. 22A to 27.

FIGS. 22 and 22B illustrate a surface profile of the platen plate 22 supporting the recording medium P and shape distortion of the outer frame F of the pattern image 200 formed on the recording medium P. FIG. 22A is an enlarged cross-sectional view of the platen plate 22 supporting the recording medium P, and FIG. 22B is a plane view illustrating the position and the shape of the outer frame F in the platen plate 22. For example, the platen plate 22 on which the recording medium P is supported includes a concave portion 22a formed on the surface and a through hole 22b formed in the bottom of the concave portion 22a. Further, in a state in which the recording medium P is supported on the platen plate 22, the recording medium P is sucked by the suction fan 35 through the through hole 22b from the back side of the platen plate 22, and thus holding force on the recording medium P increases. In this case, when the suction force of the suction fan 35 is too large, the recording medium P supported on the platen plate 22 is partially sucked along the concave portion 22a as indicated by a dotted line of FIG. 22A, and the shape distortion indicated by a dotted line of FIG. 22B occurs in the image of the outer frame F of the pattern image 200 formed on the recording medium P. Further, when the suction force of the suction fan 35 is insufficient, the recording medium P supported on the platen plate 22 partially floats as indicated by a dotted line of FIG. 22A, and the shape distortion indicated by a dotted line of FIG. 22B occurs in the image of the outer frame F of the pattern image 200 formed on the recording medium P.

When the recording medium P on which the pattern image 200 is formed is partially sunk or floats, the optical path length of the sensor unit 430 locally changes, and thus even when the image data of the colorimetric target patch CP which is the colorimetric target region is corrected by the output correcting unit 452, it is difficult to obtain a proper colorimetric value. Further, even when convex folding or concave folding occurs at the position of the recording medium P at which the pattern image 200 is formed, similarly, the optical path length of the sensor unit 430 locally changes, and thus even when the image data of the colorimetric target patch CP which is the colorimetric target region is corrected by the output correcting unit 452, it is difficult to obtain a proper colorimetric value. In this regard, in the image forming apparatus 100 according to the present embodiment, the determining unit 534 of the colorimetry control unit 50 analyzes an image obtained by capturing of the pattern image 200, and determines whether or not there is shape distortion in the outer frame F or the like. Then, when there is shape distortion in the pattern image 200, the deciding unit 535 decides not to use the image data of the colorimetric target patch CP included in the pattern image 200 for a calculation of the colorimetric value.

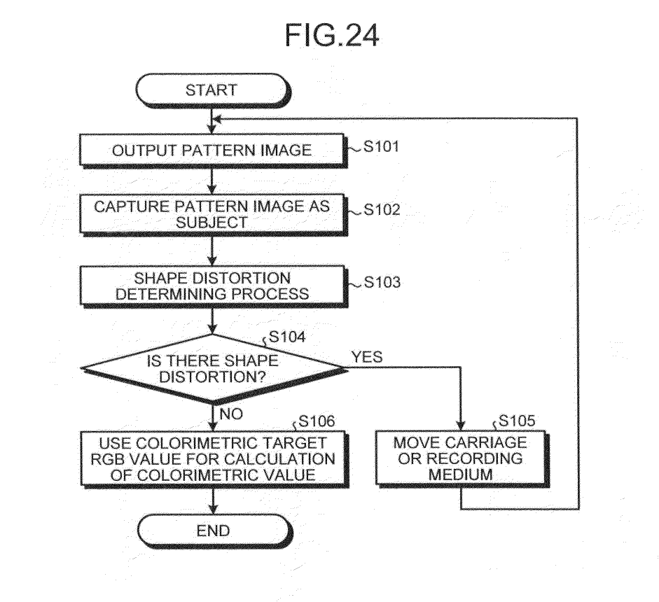

FIG. 23 is a diagram illustrating patterns of the shape distortion of the outer frame F. Illustrated in (a) of FIG. 23 is a distortion pattern when the recording medium P is partially sunk, (b) of FIG. 23 illustrates a distortion pattern when the recording medium P partially floats, (c) of FIG. 23 illustrates a distortion pattern when convex folding occurs in the recording medium P, and (d) of FIG. 23 illustrates a distortion pattern when concave folding occurs in the recording medium P. For example, the distortion patterns are registered to the non-volatile memory 56 or the like in advance. In the present embodiment, as described above, the pattern image 200 including the colorimetric target patch CP and the outer frame F is used, but when the type of the pattern image 200 is different, a distortion pattern corresponding to the type of the pattern image 200 is preferably registered to the non-volatile memory 56 or the like.

The determining unit 534 analyzes an image obtained by capturing of the pattern image 200, and when the shape of the outer frame F approximates to any one of the distortion pattern of (a) to (d) of FIG. 23, the determining unit 534 determines that the shape distortion has occurred in the pattern image 200. Further, when the determining unit 534 determines that the shape distortion has occurred in the pattern image 200, the deciding unit 535 decides that the image data of the colorimetric target patch CP included in the pattern image 200 is invalid, and informs the host CPU 107 of the fact that the image data of the colorimetric target patch CP is invalid. In this case, the host CPU 107 controls driving of the main scanning driver 109 or the sub scanning driver 113, and moves the carriage 5 or the recording medium P to change a relative position thereof. Further, the pattern image 200 is newly formed at a different position of the recording medium P.

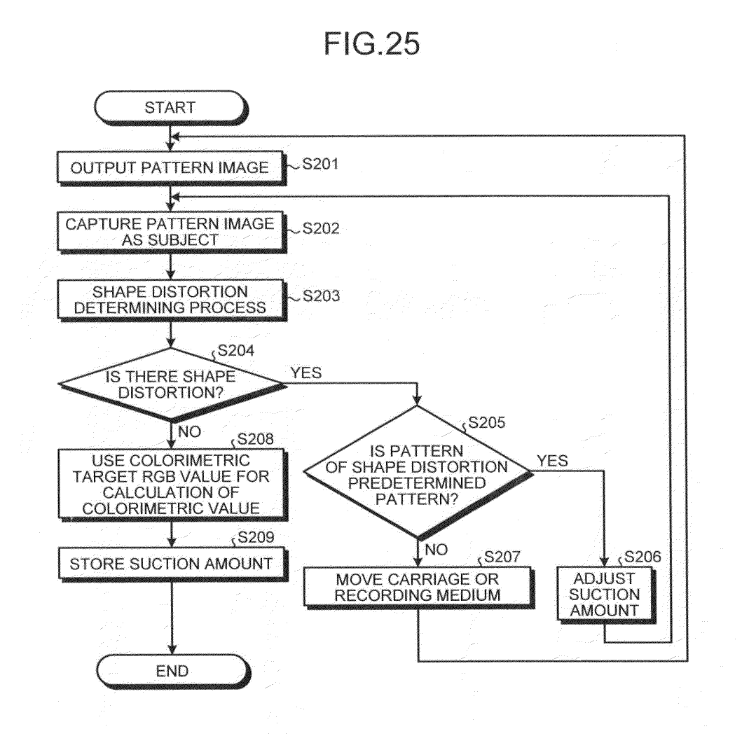

FIG. 24 is a flowchart illustrating the flow of a series of processes of determining whether or not colorimetry of the colorimetric target patch CP is to be performed according to the presence or absence of the shape distortion of the pattern image 200.

First of all, when the recording medium P is set on the platen plate 22, the host CPU 107 drives the print head driver 111 to cause ink to be ejected from the print head 6, and causes the pattern image 200 to be output onto the recording medium P (step S101).

Next, the image capturing unit 42 captures the pattern image 200 output onto the recording medium P as the subject (step S102).

Next, the determining unit 534 of the colorimetry control unit 50 analyzes the image obtained by capturing the pattern image 200 through the image capturing unit 42, and performs processing of determining the shape distortion of the pattern image 200 (step S103). For example, the determining unit 534 compares the shape of the outer frame F of the pattern image 200 recognized by image analysis with the distortion pattern previously registered to the non-volatile memory 56 or the like. Then, the determining unit 534 determines whether or not the shape distortion has occurred in the pattern image 200 as a result of the process of step S103 (step S104).

When it is determined in step S104 that the shape distortion has occurred in the pattern image 200 (Yes in S104), the deciding unit 535 decides that the image data of the colorimetric target patch CP included in the pattern image 200 is invalid, and informs the host CPU 107 of the fact that the image data of the colorimetric target patch CP is invalid. In this case, the host CPU 107 controls driving of the main scanning driver 109 or the sub scanning driver 113, and moves the carriage 5 or the recording medium P to change a relative position thereof (step S105). Then, the process returns to step S101, the pattern image 200 is output to another position of the recording medium P, and the subsequent process is repeated.

However, when it is determined in step S104 that the shape distortion has not occurred in the pattern image 200 (No in step S104), the deciding unit 535 determines that the image data of the colorimetric target patch CP included in the pattern image 200 is valid, and informs the colorimetric value calculating unit 531 of the fact that the image data of the colorimetric target patch CP is valid through the host CPU 107 or directly. In this case, the colorimetric value calculating unit 531 executes processing of calculating the colorimetric value of the colorimetric target patch CP by the above-described method based on the image data of the colorimetric target patch CP and the reference chart KC stored in the frame memory 51 (step S106).

The above description has been made in connection with the example in which the image data of the colorimetric target patch CP included in the pattern image 200 is not used to calculate the colorimetric value when the shape distortion has occurred in the pattern image 200 including the colorimetric target patch CP. However, when the shape distortion of the pattern image 200 is the partially sunk distortion pattern illustrated in (a) of FIG. 23 or the partially floating distortion pattern illustrated in (b) of FIG. 23, the shape distortion may be solved by adjusting the suction force of the suction fan 35 and causing the recording medium P on the platen plate 22 to become a flat state.

In this regard, when the determining unit 534 determines the type of occurred shape distortion as well as the presence or absence of the shape distortion of the pattern image 200, and determines that the distortion pattern of the shape distortion is the partially sunk distortion pattern illustrated in (a) of FIG. 23 or the partially floating distortion pattern illustrated in (b) of FIG. 23, the suction amount adjusting unit 57 may adjust the suction force of the suction fan 35 under control by the host CPU 107 to solve the shape distortion.

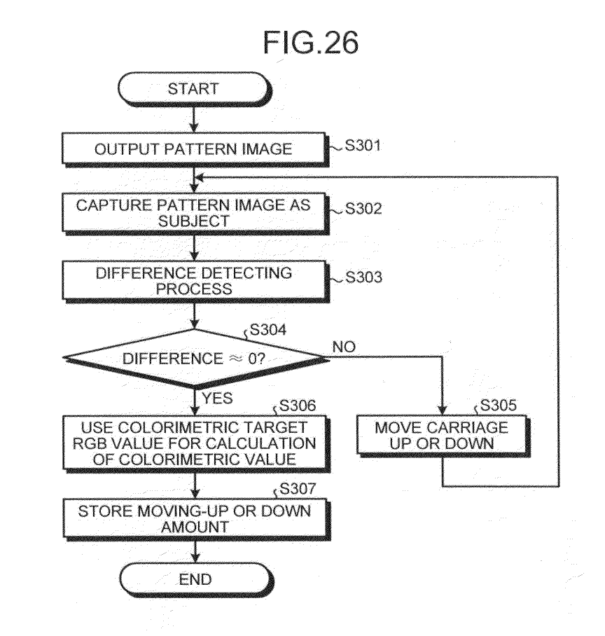

FIG. 25 is a flowchart illustrating the flow of a series of processes of determining the distortion pattern of the shape distortion of the pattern image 200 through the determining unit 534.

First of all, when the recording medium P is set on the platen plate 22, the host CPU 107 drives the print head driver 111 to cause the print head 6 to eject ink, and causes the pattern image 200 to be output onto the recording medium P (step S201).

Next, the image capturing unit 42 captures the pattern image 200 output onto the recording medium P as the subject (step S202).

Next, the determining unit 534 of the colorimetry control unit 50 analyzes the image obtained by capturing the pattern image 200 through the image capturing unit 42, and performs processing of determining the shape distortion of the pattern image 200 (step S203). For example, the determining unit 534 compares the shape of the outer frame F of the pattern image 200 recognized by image analysis with the distortion pattern previously registered to the non-volatile memory 56 or the like. Then, the determining unit 534 determines whether or not the shape distortion has occurred in the pattern image 200 as a result of the process of step S103 (step S204).

When it is determined in step S204 that the shape distortion has occurred in the pattern image 200 (Yes in S204), the determining unit 534 further determines whether or not the shape distortion occurred in the pattern image 200 has a predetermined pattern, that is, whether or not the shape distortion is the partially sunk distortion pattern or the partially floating distortion pattern (step S205).

When it is determined in step S205 that the shape distortion is the partially sunk distortion pattern or the partially floating distortion pattern (Yes in step S205), the suction amount adjusting unit 57 adjusts the suction amount of the suction fan 35 under control by the host CPU 107. In other words, when the shape distortion is the partially sunk distortion pattern, since the suction force of the suction fan 35 is too large, the suction amount of the suction fan 35 is reduced. However, when the shape distortion is the partially floating distortion pattern, since the suction force of the suction fan 35 is insufficient, the suction force of the suction fan 35 is increased. Then, after the suction force of the suction fan 35 is adjusted, the process returns to step S202, the image capturing unit 42 captures the pattern image 200, and the subsequent process is repeated.

However, when it is determined in step S205 that the shape distortion is neither the partially sunk distortion pattern nor the partially floating distortion pattern (No in step S205), the deciding unit 535 decides that the image data of the colorimetric target patch CP included in the pattern image 200 is invalid, and informs the host CPU 107 of the fact that the image data of the colorimetric target patch CP is invalid. In this case, the host CPU 107 controls driving of the main scanning driver 109 or the sub scanning driver 113, and moves the carriage 5 or the recording medium P to change a relative position thereof (step S207). Then, the process returns to step S201, the pattern image 200 is output to another position of the recording medium P, and the subsequent process is repeated.

Further, when it is determined in step S204 that the shape distortion has not occurred in the pattern image 200 (No in step S204), the deciding unit 535 decides that the image data of the colorimetric target patch CP included in the pattern image 200 is valid, and informs the colorimetric value calculating unit 531 of the fact that the image data of the colorimetric target patch CP is valid through the host CPU 107 or directly. In this case, the colorimetric value calculating unit 531 executes processing of calculating the colorimetric value of the colorimetric target patch CP by the above-described method based on the image data of the colorimetric target patch CP and the reference chart KC stored in the frame memory 51 (step S208). Then, the suction amount adjusting unit 57 causes the suction amount of the suction fan 35 at the time of capturing of the pattern image 200 to be stored in the non-volatile memory 56 or the like as the optimal suction amount (step S209). Thereafter, the suction amount adjusting unit 57 drives the suction fan 35 based on the optimal suction amount stored in the non-volatile memory 56 to optimize the suction amount of the suction fan 35.

Method of Adjusting Gap d Using Distance Between Two Points

The gap d between the image capturing unit 42 and the recording medium P is controlled by a driving time of the carriage elevating motor 30 as described above, but an error is about ±0.2 mm and relatively large. Here, in the image forming apparatus 100 according to the present embodiment, the detecting unit 532 of the colorimetry control unit 50 detects the distance n2 between the two points of the pattern image 200 from the image obtained by capturing the pattern image 200 through the image capturing unit 42, and the non-volatile memory 56 stores the distance n1 between the two points of the pattern image 200 when the gap d is the reference value d1 as the reference distance. Thus, the gap d can be approximated to the reference value d1 by controlling driving of the carriage elevating motor 30 such that the difference between the distance n2 between the two points detected by the detecting unit 532 and the reference distance n1 is approximated to zero.

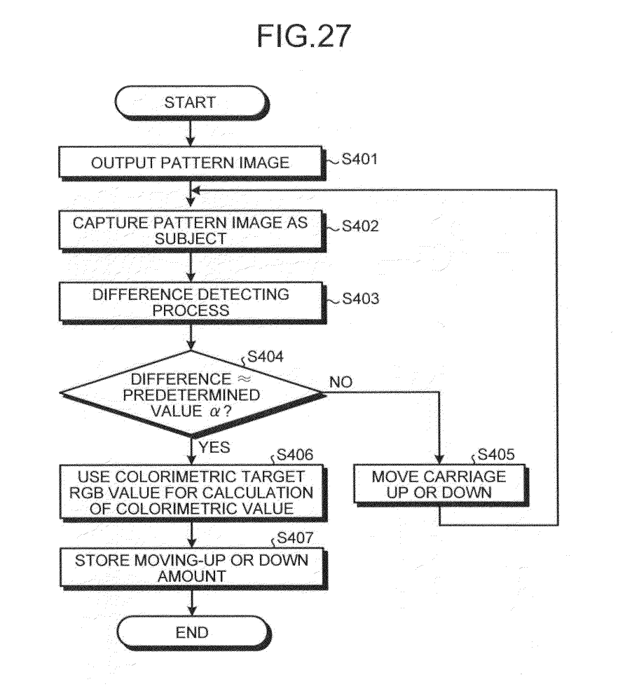

FIG. 26 is a flowchart illustrating the flow of a series of processes of adjusting the gap d using the distance between the two points detected by the detecting unit 532.

First of all, when the recording medium P is set on the platen plate 22, the host CPU 107 drives the print head driver 111 to cause the print head 6 to eject ink, and causes the pattern image 200 to be output onto the recording medium P (step S301).

Next, the image capturing unit 42 captures the pattern image 200 output onto the recording medium P as the subject (step S302).

Next, the detecting unit 532 of the colorimetry control unit 50 analyzes the image obtained by capturing the pattern image 200 through the image capturing unit 42, detects the distance n2 between the two points of the pattern image 200, and informs the host CPU 107 of the distance n2 between the detected two points. Then, the host CPU 107 detects the difference between the distance n2 between the two points detected by the detecting unit 532 and the reference distance n1 stored in the non-volatile memory 56 (step S303), and determines whether or not the detected difference is almost zero (step S304).

When it is determined in step S304 that the difference is not almost zero (No in step S304), the host CPU 107 outputs a control command to the gap adjusting unit 52, drives the carriage elevating motor 30, for example, at predetermined minimum unit time intervals, and moves the carriage 5 up or down. Then, after moving the carriage 5 up or down, the process returns to step S302, capturing of the pattern image 200 is performed through the image capturing unit 42, and the subsequent process is repeated.

However, when it is determined in step S304 that the difference is almost zero (Yes in step S304), the host CPU 107 informs the colorimetric value calculating unit 531 of the fact that the image data of the colorimetric target patch CP is valid. In this case, the colorimetric value calculating unit 531 executes processing of calculating the colorimetric value of the colorimetric target patch CP by the above-described method based on the image data of the colorimetric target patch CP and the reference chart KC stored in the frame memory 51 (step S306). Then, the gap adjusting unit 52 causes the moving-up or down amount of the carriage 5 of the pattern image 200 to be stored in the non-volatile memory 56 or the like as the optimal moving-up or down amount when the gap d is the reference value d1 (step S307). Thereafter, when the gap d is set to the reference value d1, the gap adjusting unit 52 drives the carriage elevating motor 30 based on the optimal moving-up or down amount stored in the non-volatile memory 56 and thus can properly set the gap d to the reference value d1.

The above description has been made in connection with the example in which the gap d is set to the reference value d1, but even when the operation mode called the “thick sheet mode” or the “rubbing avoiding mode” is selected and so the gap d is set to d2, the gap d can be adjusted by a similar method.

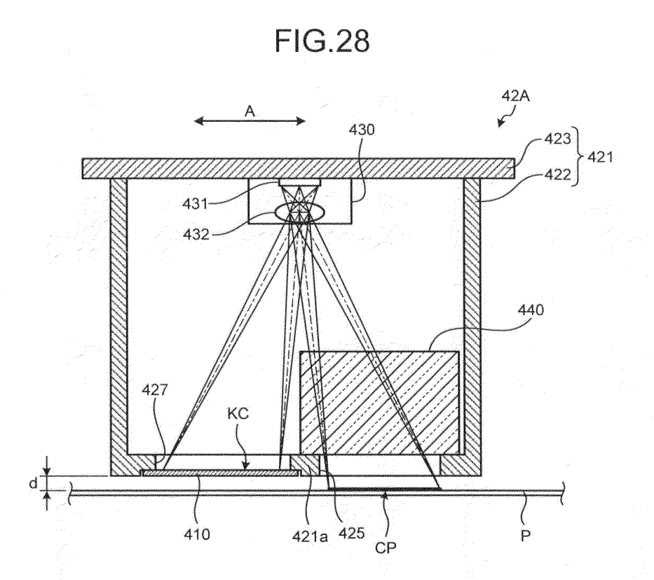

FIG. 27 is a flowchart illustrating the flow of a series of processes of adjusting the gap d using the distance between the two points detected by the detecting unit 532 when the gap d is set to d2.

First of all, when the recording medium P is set on the platen plate 22, the host CPU 107 drives the print head driver 111 to cause the print head 6 to eject ink, and causes the pattern image 200 to be output onto the recording medium P (step S401).

Next, the image capturing unit 42 captures the pattern image 200 output onto the recording medium P as the subject (step S402).

Next, the detecting unit 532 of the colorimetry control unit 50 analyzes the image obtained by capturing the pattern image 200 through the image capturing unit 42, detects the distance n2 between the two points of the pattern image 200, and informs the host CPU 107 of the distance n2 between the detected two points. Then, the host CPU 107 detects the difference between the distance n2 between the two points detected by the detecting unit 532 and the reference distance n1 stored in the non-volatile memory 56 (step S403), and determines whether or not the difference is almost a predetermined value a (step S404). Here, the predetermined value α is a difference with the reference distance which is measured in advance in a state in which the gap d is set to d2, and stored in, for example, the non-volatile memory 56 or the like.

When it is determined in step S404 that the difference is not almost the predetermined value a (No in step S404), the host CPU 107 outputs a control command to the gap adjusting unit 52, drives the carriage elevating motor 30, for example, at predetermined minimum unit time intervals, and moves the carriage 5 up or down. Then, after moving the carriage 5 up or down, the process returns to step S402, capturing of the pattern image 200 is performed through the image capturing unit 42, the subsequent process is repeated.

However, when it is determined in step S404 that the difference is almost the predetermined value a (Yes in step S404), the host CPU 107 informs the colorimetric value calculating unit 531 of the fact that the image data of the colorimetric target patch CP is valid. In this case, the colorimetric value calculating unit 531 executes processing of calculating the colorimetric value of the colorimetric target patch CP by the above-described method based on the image data of the colorimetric target patch CP and the reference chart KC stored in the frame memory 51 (step S406). Then, the gap adjusting unit 52 causes the moving-up or down amount of the carriage 5 of the pattern image 200 to be stored in the non-volatile memory 56 or the like as the optimal moving-up or down amount when the gap d is d2 (step S407). Thereafter, when the gap d is set to d2, the gap adjusting unit 52 drives the carriage elevating motor 30 based on the optimal moving-up or down amount stored in the non-volatile memory 56 and thus can properly set the gap d to d2.

Modifications of Image Capturing Unit

Next, modifications of the image capturing unit 42 will be described. In the following, an image capturing unit 42 of a first modification is referred to as an image capturing unit 42A, an image capturing unit 42 of a second modification is referred to as an image capturing unit 42B, an image capturing unit 42 of a third modification is referred to as an image capturing unit 42C, an image capturing unit 42 of a fourth modification is referred to as an image capturing unit 42D, an image capturing unit 42 of a fifth modification is referred to as an image capturing unit 42E, and an image capturing unit 42 of a sixth modification is referred to as an image capturing unit 42F. In the modifications, the same components as in the above-described image capturing unit 42 are denoted by the same reference numerals, and a redundant description will not be repeated.

First Modification

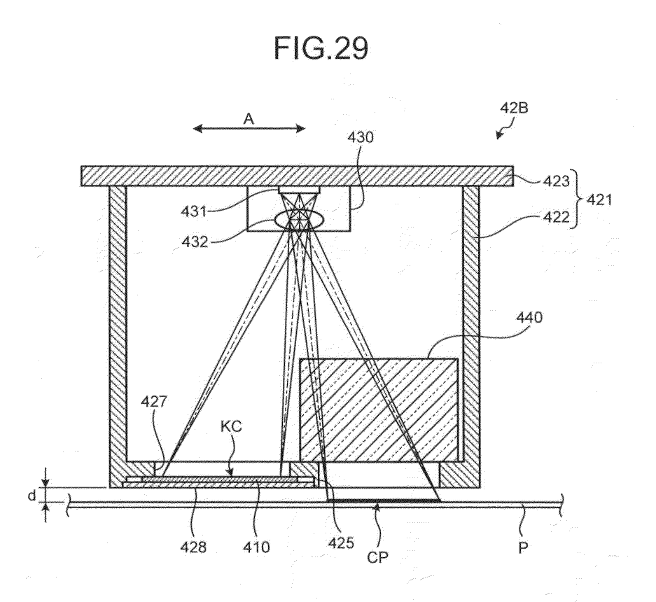

FIG. 28 is a vertical cross-sectional view of an image capturing unit 42A of the first modification and a cross-sectional diagram at the same position as the vertical cross-sectional view of the image capturing unit 42 illustrated in FIG. 5A.

In the image capturing unit 42A of the first modification, an opening portion 427 separate from the opening portion 425 through the colorimetric target patch CP is captured is formed in the bottom portion 421a of the housing 421. Further, the chart board 410 is arranged to block the opening portion 427 from the external side of the housing 421. In other words, in the image capturing unit 42, the chart board 410 is arranged on the internal side of the housing 421 facing the sensor unit 430 of the bottom portion 421a, whereas in the image capturing unit 42A of the first modification, the chart board 410 is arranged on the external side of the bottom portion 421a of the housing 421 facing the recording medium P.

Specifically, for example, a concave portion having the depth corresponding to the thickness of the chart board 410 is formed on the external side of the bottom portion 421a of the housing 421 to communicate with the opening portion 427. Further, the chart board 410 is arranged in the concave portion such that the surface on which the reference chart KC is formed faces the sensor unit 430 side. For example, the chart board 410 is formed to be integrated with the housing 421 such that the end portion of the chart board 410 adheres to the bottom portion 421a of the housing 421 at the position near to the end edge of the opening portion 427 by an adhesive.

In the image capturing unit 42A of the first modification having the above configuration, the chart board 410 on which the reference chart KC is formed is arranged on the external side of the bottom portion 421a of the housing 421. Thus, compared to the image capturing unit 42, the difference between the optical path length from the sensor unit 430 to the colorimetric target patch CP and the optical path length between the sensor unit 430 to the reference chart KC can be reduced.

Second Modification

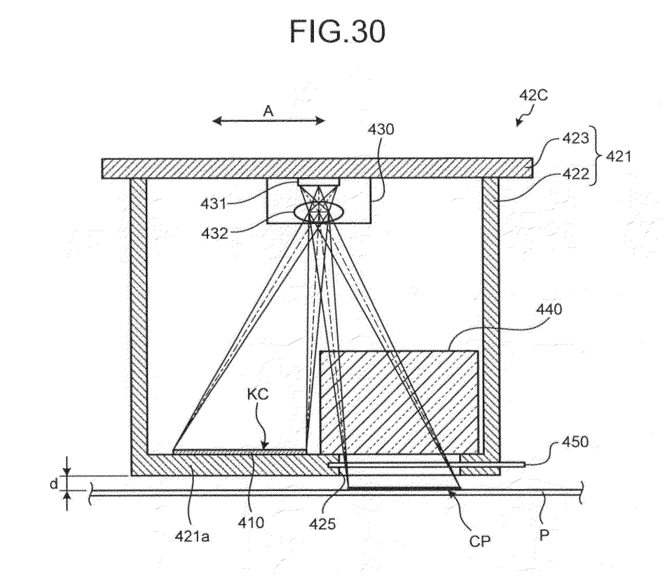

FIG. 29 is a vertical cross-sectional view of an image capturing unit 42B of the second modification and a cross-sectional diagram at the same position as the vertical cross-sectional view of the image capturing unit 42 illustrated in FIG. 5A.

In the image capturing unit 42B of the second modification, similarly to the image capturing unit 42A of the first modification, the chart board 410 is arranged on the external side of the bottom portion 421a of the housing 421. In the image capturing unit 42A of the first modification, the chart board 410 adheres to the bottom portion 421a of the housing 421 through an adhesive or the like and is integrated with the housing 421, whereas in the image capturing unit 42B of the second modification, the chart board 410 is removably held to the housing 421.

Specifically, for example, similarly to the image capturing unit 42A of the first modification, a concave portion communicating with the opening portion 427 is formed on the external side of the bottom portion 421a of the housing 421, and the chart board 410 is arranged in the concave portion. Further, the image capturing unit 42B of the second modification further includes a holding member 428 that presses down and holds the chart board 410 arranged in the concave portion from the external side of the bottom portion 421a of the housing 421. The holding member 428 is removably mounted to the bottom portion 421a of the housing 421. Thus, in the image capturing unit 42B of the second modification, the chart board 410 can be taken out by removing the holding member 428 from the bottom portion 421a of the housing 421.

As described above, in the image capturing unit 42B of the second modification, the chart board 410 is removably held to the housing 421, and the chart board 410 can be taken out. Thus, when the reference chart KC is contaminated and so the chart board 410 degrades, a work of replacing the chart board 410 can be simply performed. Further, when shading data used to correct uneven illumination by the illumination light source 426 through the shading correcting unit 453 is acquired, a white reference plate may be arranged without taking out the chart board 410, and the white reference plate may be captured by the sensor unit 430, so that shading data can be conveniently acquired.

Third Modification

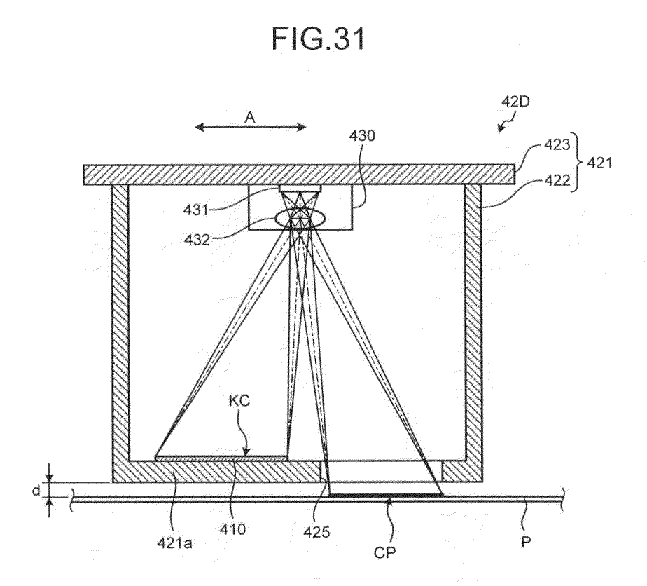

FIG. 30 is a vertical cross-sectional view of an image capturing unit 42C of the third modification and a cross-sectional diagram at the same position as the vertical cross-sectional view of the image capturing unit 42 illustrated in FIG. 5A.

In the image capturing unit 42C of the third modification, a mist blocking permeation member 450 that blocks the opening portion 425 of the housing 421 is added. The image forming apparatus 100 according to the present embodiment is configured to eject ink from a row of nozzles of the print head 6 mounted in the carriage 5 onto the recording medium P on the platen plate 22 and form an image on the recording medium P as described above. For this reason, when ink is ejected from a row of nozzles of the print head 6, mist-like small ink particles (hereinafter a small ink particle is referred to as a “mist”) are generated. Further, when mists generated at the time of image forming enter the inside of the housing 421 from the outside of the housing 421 of the image capturing unit 42 installed to be fixed to the carriage 5 through the opening portion 425, the mists that have entered the housing 421 are attached to the sensor unit 430, the illumination light source 426, the optical path length changing member 440, or the like, and thus when color adjustment of performing colorimetry of the colorimetric target patch CP is performed, it may be difficult to obtain accurate image data. In this regard, in the image capturing unit 42C of the third modification, the opening portion 425 formed in the bottom portion 421a of the housing 421 is covered with the mist blocking permeation member 450, and thus mists generated at the time of image forming are prevented from entering the inside of the housing 421.

The mist blocking permeation member 450 is a transparent optical element having sufficient permeability on light of the illumination light source 426, and is configured in the form of a plate with the size enough to cover the entire opening portion 425. The mist blocking permeation member 450 is mounted in a slit formed along the bottom portion 421a of the housing 421, and closes the whole surface of the opening portion 425 formed in the bottom portion 421a of the housing 421. The slit in which the mist blocking permeation member 450 is mounted has an opening at the side portion of the housing 421. The mist blocking permeation member 450 can be inserted through the side portion of the housing 421 and mounted in the slit. Further, the mist blocking permeation member 450 can be removed through the side portion of the housing 421 and can be appropriately exchanged, for example, when a contaminant is attached.

Fourth Modification

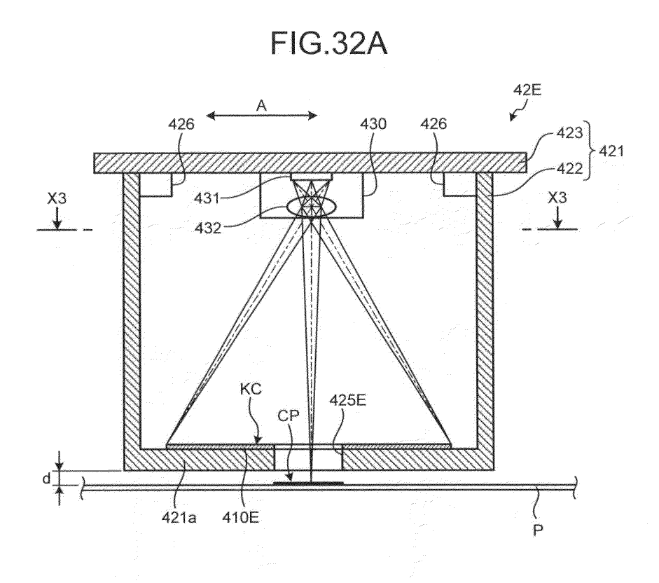

FIG. 31 is a vertical cross-sectional view of an image capturing unit 42D of the fourth modification and a cross-sectional diagram at the same position as the vertical cross-sectional view of the image capturing unit 42 illustrated in FIG. 5A.

In the image capturing unit 42C of the fourth modification, the optical path length changing member 440 inside the housing 421 is not arranged. The optical path length changing member 440 has a function of changing the optical path length from the sensor unit 430 to the subject (the colorimetric target patch CP) to match the optical path length from the sensor unit 430 to the reference chart KC as described above. However, when the difference between the optical path lengths is within the depth of field of the sensor unit 430, even when there is a difference in the optical path length, it is possible to capture an image that is focused on both the subject (the colorimetric target patch CP) and the reference chart KC.

The difference between the optical path length from the sensor unit 430 to the subject (the colorimetric target patch CP) and the optical path length from the sensor unit 430 to the reference chart KC generally has a value obtained by adding the gap d to the thickness of the bottom portion 421a of the housing 421. Thus, when the gap d is set to a sufficiently small value, the difference between the optical path length from the sensor unit 430 to the subject (the colorimetric target patch CP) and the optical path length from the sensor unit 430 to the reference chart KC can be within the range of the depth of field of the sensor unit 430, and the component cost can be reduced by omitting the optical path length changing member 440.

In addition, the depth of field of the sensor unit 430 is decided according to an aperture value of the sensor unit 430, a focal length of the imaging lens 432, a distance between the sensor unit 430 and the subject, or the like, and has a characteristic specific to the sensor unit 430. In the image capturing unit 42D of the present modification, the sensor unit 430 is designed so that the difference between the optical path length from the sensor unit 430 to the subject (the colorimetric target patch CP) and the optical path length from the sensor unit 430 to the reference chart KC is within the depth of field when the gap d between the bottom portion 421a of the housing 421 and the recording medium P is set to a sufficiently small value, for example, about 1 mm to 2 mm.

Fifth Modification

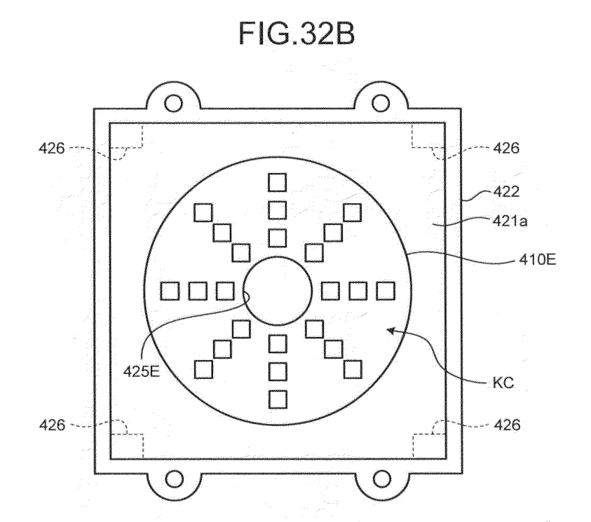

FIG. 32A is a vertical cross-sectional view of an image capturing unit 42E of the fifth modification and a cross-sectional diagram at the same position as the vertical cross-sectional view of the image capturing unit 42 illustrated in FIG. 5A. FIG. 32B is a plane view illustrating the bottom portion 421a of the housing 421 viewed from an X3 direction in FIG. 32A. In FIG. 32B, a vertical projection position (the position at which light is projected when the bottom portion 421a is looked down) of the illumination light source 426 in the bottom portion 421a of the housing 421 is indicated by a dotted line.

In the image capturing unit 42E of the fifth modification, an opening portion 425E is formed in the bottom portion 421a of the housing 421 at the position on a vertical line (that is, an optical axis center of the sensor unit 430) when the bottom portion 421a is looked down from the sensor unit 430, and image capturing of the subject (the colorimetric target patch CP) is performed through the opening portion 425E. In other words, in the image capturing unit 42E of the fifth modification, the opening portion 425E through which the subject (the colorimetric target patch CP) outside the housing 421 is captured is formed to be positioned substantially at the center of the imaging area of the sensor unit 430.

Further, in the image capturing unit 42E of the fifth modification, the chart board 410E on which the reference chart KC is formed on the bottom portion 421a of the housing 421 to surround the opening portion 425E. For example, the chart board 410E is formed to have an annular shape centering on the opening portion 425E, adheres to the internal side of the bottom portion 421a of the housing 421 through an adhesive using the surface on which the reference chart KC is formed as an adhesive surface, and is held in a state in which the chart board 410E is fixed to the housing 421.

Further, in the image capturing unit 42E of the fifth modification, four LEDs arranged at four corners at the inner circumferential side of the frame 422 configuring the sidewall of the housing 421 are used as the illumination light source 426. For example, the four LEDs used as the illumination light source 426 are mounted inside the substrate 423 together with the 2D image sensor 431 of the sensor unit 430. As the four LEDs used as the illumination light source 426 are arranged as described above, it is possible to illuminate the subject (the colorimetric target patch CP) and the reference chart KC substantially at the same condition.

In the image capturing unit 42E of the fifth modification having the above-described configuration, the opening portion 425E through which the subject (the colorimetric target patch CP) outside the housing 421 is captured is formed on the vertical line from the sensor unit 430 in the bottom portion 421a of the housing 421, and the chart board 410E on which the reference chart KC is formed is arranged to surround the opening portion 425E. Thus, it is possible to appropriately image the subject (the colorimetric target patch CP) and the reference chart KC.

Sixth Modification

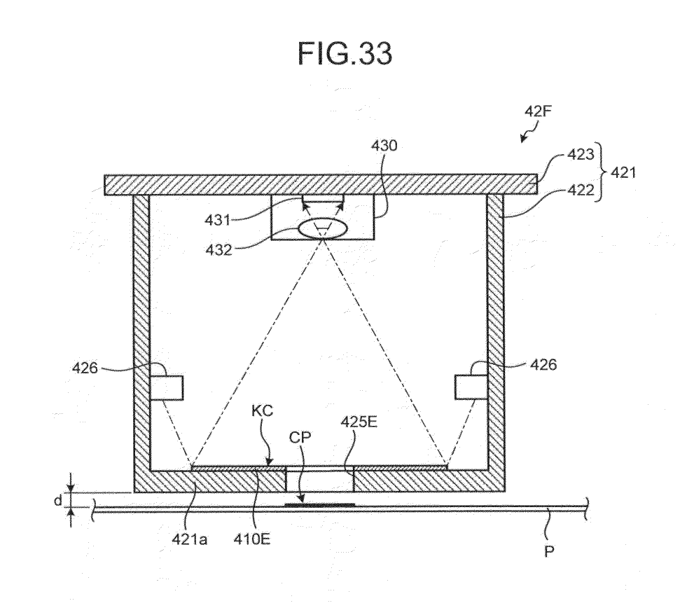

FIG. 33 is a vertical cross-sectional view of an image capturing unit 42F of the sixth modification and a cross-sectional diagram at the same position as the vertical cross-sectional view of the image capturing unit 42 illustrated in FIG. 5A.

In the image capturing unit 42F of the sixth modification, similarly to the image capturing unit 42E of the fifth modification, four LEDs arranged at four corners at the inner circumferential side of the frame 422 are arranged as the illumination light source 426. Here, in the image capturing unit 42F of the sixth modification, in order to prevent regular-reflected light regular-reflected by the subject (the colorimetric target patch CP) or the reference chart KC from being incident to the 2D image sensor 431 of the sensor unit 430, four LEDs used as the illumination light source 426 are arranged at the position closer to the bottom portion 421a of the housing 421 than in the image capturing unit 42E of the fifth modification.

In the sensor plane of the 2D image sensor 431 of the sensor unit 430, it may be difficult to obtain accurate information at the position at which regular-reflected light of the illumination light source 426 is incident because a pixel value is saturated. For this reason, when the illumination light source 426 is arranged at the position at which regular-reflected light regularly reflected from the subject (the colorimetric target patch CP) or the reference chart KC is incident to the 2D image sensor 431 of the sensor unit 430, it is difficult to obtain information necessary for colorimetry of the subject (the colorimetric target patch CP). In this regard, in the image capturing unit 42F of the sixth modification, as illustrated in FIG. 33, four LEDs used as the illumination light source 426 are arranged at the position close to the bottom portion 421a of the housing 421, and thus regular-reflected light regularly reflected from the subject (the colorimetric target patch CP) or the reference chart KC is not incident to the 2D image sensor 431 of the sensor unit 430. An arrow indicated by an alternate long and short dash line in FIG. 33 is an image illustrating an optical path of regular-reflected light.

As described above, in the image capturing unit 42F of the sixth modification, the illumination light source 426 is arranged at the position at which regular-reflected light regularly reflected from the subject (the colorimetric target patch CP) or the reference chart KC is not incident to the 2D image sensor 431 of the sensor unit 430. Thus, it is possible to effectively prevent a pixel value from being saturated at the position at which an optical image of the subject (the colorimetric target patch CP) or the reference chart KC is formed in the sensor plane of the 2D image sensor 431, and the subject (the colorimetric target patch CP) and the reference chart KC can be appropriately performed.

Other Modification

In the image capturing unit 42 and the modifications, the reference chart KC is disposed in the housing 421, the sensor unit 430 simultaneously captures the subject (the colorimetric target patch CP) and the reference chart KC. However, as described above, the initial reference RGB value or the colorimetry reference RGB value obtained by capturing of the reference chart KC is used to remove influence of the temporal change of the imaging condition of the image capturing unit 42 such as the temporal change of the illumination light source 426 or the temporal change of the 2D image sensor 431 on the colorimetric target RGB value obtained by capturing of the colorimetric target patch CP. In other words, the initial reference RGB value or the colorimetry reference RGB value obtained by capturing of the reference chart KC is used to calculate the reference inter-RGB linear conversion matrix and convert the colorimetric target RGB value into the initialization colorimetric target RGB value (RₛGₛBₛ) using the reference inter-RGB linear conversion matrix.

Thus, when the temporal change of the imaging condition of the image capturing unit 42 is ignorable on the required accuracy of colorimetry, the image capturing unit 42 having the configuration including no reference chart KC can be used. When the image capturing unit 42 having the configuration including no reference chart KC is used, processing (step S10 in FIG. 11) of converting the colorimetric target RGB value obtained by capturing the colorimetric target patch CP through the image capturing unit 42 into the initialization colorimetric target RGB value is not performed, and the basic colorimetry process (step S20 of FIG. 11 and FIGS. 14 and 15) is performed on the colorimetric target RGB value.

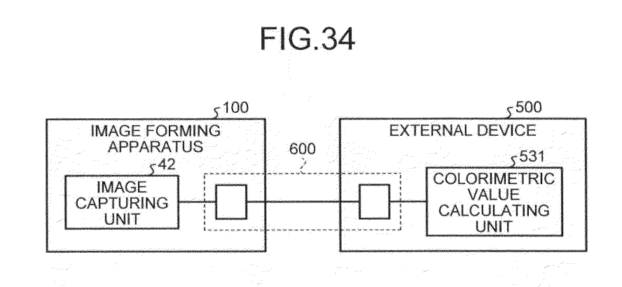

Further, the image forming apparatus 100 according to the present embodiment performs the colorimetry process through the colorimetry control unit 50, but the colorimetry process needs not be necessarily executed inside the image forming apparatus 100. For example, as illustrated in FIG. 34, an image forming system (a colorimetric system) may be constructed such that the image forming apparatus 100 and an external device 500 are connected to perform communication with each other, the function of the colorimetric value calculating unit 531 may be given to the external device 500, and the colorimetry process may be performed in the external device 500. In other words, the colorimetric system includes the image forming apparatus 100 including the image capturing unit 42, the external device 500 having at least the function of the colorimetric value calculating unit 531, and a communication unit 600 through which the image forming apparatus 100 is connected with the external device 500. For example, a computer called a digital front end (DFE) can be used as the external device 500. Further, the communication unit 600 can use not only wired or wireless P2P communication but also communication using a network such as a local area network (LAN) or the Internet.

In this case, for example, the image forming apparatus 100 transmits the image data of the colorimetric target patch CP and the reference chart KC captured by the image capturing unit 42 to the external device 500 through the communication unit 600. The external device 500 calculates the colorimetric value of the colorimetric target patch CP using the image data received from the image forming apparatus 100, and generates a color conversion parameter for improving color reproducibility of the image forming apparatus 100 based on the calculated colorimetric value of the colorimetric target patch CP. Then, the external device 500 transmits the generated color conversion parameter to the image forming apparatus 100 through the communication unit 600. The image forming apparatus 100 holds the color conversion parameter received from the external device 500, corrects the image data using the color conversion parameter when image forming is performed, and performs image forming based on the corrected image data. Thus, the image forming apparatus 100 can form an image having high color reproducibility.

Further, the external device 500 may hold the color conversion parameter generated based on the colorimetric value of the colorimetric target patch CP, and the image data may be corrected in the external device 500. In other words, the image forming apparatus 100 transmits the image data to the external device 500 when image forming is performed. The external device 500 corrects the image data received from the image forming apparatus 100 using the color conversion parameter held therein, and transmits the corrected image data to the image forming apparatus 100. The image forming apparatus 100 performs image forming based on the corrected image data received from the external device 500. Thus, the image forming apparatus 100 can form an image having high color reproducibility.

As described above in detail using the concrete examples, in the image forming apparatus 100 according to the present embodiment, the image capturing unit 42 is configured to capture the subject outside the housing 421 uniformly illuminated by the illumination light source 426 through the sensor unit 430 installed inside the housing 421 through the opening portion 425 of the housing 421. Further, the detecting unit 532 of the colorimetry control unit 50 detects a distance between predetermined two points from the image data obtained by image capturing of the sensor unit 430, and the correction factor calculating unit 533 calculates the correction factor according to the ratio of the detected distance between the two points to the reference distance. Further, the image data (the colorimetric target RGB value) of the colorimetric target patch CP which is the subject is corrected using the correction factor, and the colorimetric value calculating unit 531 calculates the colorimetric value of the colorimetric target patch CP using the corrected colorimetric target RGB value. Thus, an error of the image data of the colorimetric target patch CP occurring due to the change in the gap d between the image capturing unit 42 and the recording medium P on which the colorimetric target patch CP is formed can be appropriately corrected, and the colorimetric value of the colorimetric target CP can be calculated with a high degree of accuracy. As described above, according to the image forming apparatus 100 according to the present embodiment, it is possible to acquire the stable image data from the subject of the colorimetric target and perform accurate colorimetry.

Further, according to the image forming apparatus 100 according to the present embodiment, the determining unit 534 of the colorimetry control unit 50 detects the presence or absence of the shape distortion of the subject image (for example, the pattern image 200 including the colorimetric target patch CP), and when the subject image has the shape distortion, the deciding unit 535 does not use the image data of the colorimetric target patch CP which is the subject for the colorimetry. Thus, a problem in which an erroneous colorimetric value is calculated using the image data whose value partially changes can be suppressed, and the accurate colorimetry can be performed.

Further, according to the image forming apparatus 100 according to the present embodiment, the determining unit 534 determines not only the presence or absence of the shape distortion of the subject image but also whether or not the distortion pattern has a predetermined pattern (the partially sunk pattern or the partially floating pattern), and when it is determined that the shape distortion of the subject image has the predetermined pattern, the suction force of the suction fan 35 is adjusted. Thus, a problem in which the image of the colorimetric target patch CP that can be used to calculate the colorimetric value is uselessly discarded can be effectively suppressed.

Furthermore, according to the image forming apparatus 100 according to the present embodiment, the gap d can be properly set to d1 or d2 using the distance between the two points of the pattern image 200 detected by the detecting unit 532, and thus the colorimetric value of the colorimetric target patch CP can be calculated with a high degree of accuracy.

In addition, the control functions of the components configuring the image forming apparatus 100 according to the present embodiment or the color measuring device can be implemented using hardware, software, and a combination thereof. When the control functions of the components configuring the image forming apparatus 100 according to the present embodiment or the color measuring device are implemented by software, a processor installed in the image forming apparatus 100 or the color measuring device executes a program describing a processing sequence. For example, the program executed by the processor is embedded in a ROM or the like in the image forming apparatus 100 or the color measuring device and provided. Further, the program executed by the processor is a file having an installable format or an executable format, and may be recorded in a computer readable storage medium such as a CD-ROM, a flexible disk (FD), a CD-R, and a digital versatile disc (DVD) and provided.

Furthermore, the program executed by the processor may be configured to be stored in a computer connected to a network such as the Internet, downloaded through the network and then provided. Furthermore, the program executed by the processor may be configured to be provided or distributed via a network such as the Internet.

According to the embodiments, there are effects by which stable image data can be acquired from a subject of a colorimetric target, and thus high-accuracy colorimetry can be performed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A color measuring device comprising:
a housing;
a sensor unit configured to capture an image of a region, the sensor unit being held to the housing;
an illumination light source configured to illuminate the region, the illumination light source being held to the housing;
a detecting unit configured to detect a distance between predetermined two points from image data of the region obtained by the sensor unit;
a correcting unit configured to correct the image data including a subject whose color is to be measured according to a ratio of the detected distance to a reference distance; and
a calculating unit configured to calculate a colorimetric value of the subject based on the corrected image data.

2. The color measuring device according to claim 1, further comprising:
a determining unit configured to determine shape distortion of an image of the subject; and
a deciding unit configured to decide whether the image data is to be used to calculate the colorimetric value of the subject based on the presence or absence of the shape distortion or a type of the shape distortion.

3. The color measuring device according to claim 2, further comprising,
a suction amount adjusting unit configured to adjust an amount of suction generated by a sucking unit for holding the subject on a holding member when the shape distortion is distortion of a predetermined pattern.

4. The color measuring device according to claim 1, further comprising,
a position adjusting unit configured to adjust a position of the housing in an optical axis direction of the sensor unit such that a difference between the detected distance and the reference distance approximates to zero.

5. The color measuring device according to claim 1, further comprising,
a position adjusting unit configured to adjust a position of the housing in an optical axis direction of the sensor unit such that a difference between the detected distance between the two points and the reference distance approximates to a predetermined value.

6. The color measuring device according to claim 1,
wherein the detecting unit detects the distance between the two points from the image data including the subject.

7. The color measuring device according to claim 1,
wherein the detecting unit detects the distance between the two points from the image data that does not include the subject.

8. The color measuring device according to claim 1, further comprising a reference chart whose image is to be captured together with the subject by the sensor unit, the reference chart portion being held to the housing,
wherein the detecting unit detects the reference distance from the image of the reference chart included in the image data.

9. An image forming apparatus comprising:
an image output unit configured to output an image to a recording medium; and
the color measuring device according to claim 1,
wherein the color measuring device calculates a colorimetric value of the image using the image output from the image output unit as the subject.

10. A colorimetric system comprising:
an image capturing unit configured to capture an image of a subject whose color is to be measured; and
a calculating unit configured to calculate a colorimetric value of the subject, wherein
the image capturing unit includes
a housing,
a sensor unit configured to capture an image of a region, the sensor unit being held to the housing,
an illumination light source configured to illuminate the region, the illumination light source being held to the housing,
a detecting unit configured to detect a distance between predetermined two points from image data of the region obtained by the sensor unit, and
a correcting unit configured to correct the image data including a subject whose color is to be measured according to a ratio of the detected distance to a reference distance, and
the calculating unit calculates the colorimetric value of the subject based on the image data that has been corrected by the correcting unit.

11. A color measuring method executed in a color measuring device that includes a housing, a sensor unit configured to capture an image of a region, the sensor unit being held to the housing, and an illumination light source configured to illuminate the region, the illumination light source being held to the housing, the color measuring method comprising:
detecting a distance between predetermined two points from image data of the region obtained by the sensor unit;
correcting the image data including a subject whose color is to be measured according to a ratio of the detected distance to a reference distance; and
calculating a colorimetric value of the subject based on the corrected image data.
